(19) United States
(12) Patent Application Publication
(10) Pub. No.: US 2026/0210832 A1
(43) Pub. Date: Jul. 23, 2026

(54) POINT-OF-CARE DEVICES AND METHODS FOR BIOPSY ASSESSMENT

(71) Applicant: Pathware,, Inc., Golden, CO (US)

(72) Inventors: John W. Meyer, Urbandale, IA (US); Torsten M. Lyon, Golden, CO (US); Troy L. Holsing, Golden, CO (US)

(21) Appl. No.: 19/140,144

(22) PCT Filed: Dec. 13, 2023
(86) PCT No.: PCT/US23/83867

§ 371 Date: Jun. 17, 2025

Related U.S. Application Data
(60) Provisional application No. 63/476,444, filed on Dec. 21, 2022.

(51) Int. Cl. G01N 15/1429; G01N 15/14; G06T 7/00; G06V 20/69

(52) U.S. Cl. CPC G01N 15/1431; G06T 7/0012; G06V 20/698; G01N 2015/1486; G06T 2207/10056; G06T 2207/20081; G06T 2207/20132; G06T 2207/20212; G06T 2207/30004

(57) ABSTRACT

A point-of-care device for biopsy assessment includes a receptacle for receiving a biological sample; a light source for emitting light at a single or plurality of wavelengths and illuminate at least a portion of the biological sample; an image sensor for receiving at least a portion of the emitted light and convert at least the portion of the emitted light to a signal; a memory to store processor-executable instructions; and a processor coupled to the memory and the image sensor. The instructions cause the processor to: receive the signal from the image sensor; convert the signal into a first image representing the biological sample; identify a first cell type represented in the first image; determine whether a quality of the biological sample is above a predefined; and when the quality is above the predefined threshold, generate an indication of an adequacy and/or diagnostics of the biological sample.

### CROSS REFERENCE TO RELATED APPLICATIONS

This application claims the priority benefit of U.S. Provisional Patent Application Ser. No. 63/476,444, filed Dec. 21, 2022, the contents of which is herein incorporated by reference in its entirety.

### INCORPORATION BY REFERENCE

All publications and patent applications mentioned in this specification are herein incorporated by reference in their entirety, as if each individual publication or patent application was specifically and individually indicated to be incorporated by reference in its entirety.

### TECHNICAL FIELD

This disclosure relates generally to the field of pathology, and more specifically to the field of point-of-care pathology and/or cytopathology. Described herein are point-of-care devices and methods for biopsy assessment and/or diagnostics.

### BACKGROUND

Biopsies are commonly performed in medical procedures that remove tissue from a patient by a clinician or surgeon for analysis by a pathologist. Hospitals are typically under-reimbursed for this procedure due to the frequent need to repeat it to obtain a sample large enough to determine a diagnosis. In fact, one in five biopsies taken in the U.S. fail to return a diagnosis. Further, according to a 2020 report, repeat biopsies occur in about 46% of cases.

To address this challenge, hospitals have developed a protocol for on-site (i.e., in the operating room) assessment of the biopsy to ensure that a sufficiently large sample was collected. Rapid on-site evaluation (ROSE) is a technique used in clinical medicine to help validate the adequacy of tissue biopsies at the point-of-care. It is primarily used for fine needle aspiration (FNA) procedures and has been used for various tissues and with different stains. The value hospitals find with implementing ROSE is in reducing failed procedure rates, and for cancer, decreasing time to diagnosis and treatment. However, others argue that using a pathologist's time for ROSE instead of in the lab looking at case samples represents a significant drawback to the technique.

Alternatively, in some hospitals, a sample or aspirate is taken from the patient, and the patient is sent home while the sample is reviewed by a pathologist for adequacy, quality, and/or diagnostic purposes. The review process can, at minimum, take days, and worst-case scenario, weeks or months.

Accordingly, more efficient and effective devices and methods are needed to assess biopsies more rapidly.

### SUMMARY

In some aspects, the techniques described herein relate to a point-of-care device for biopsy assessment, the device including: a receptacle configured to receive a biological sample therein or thereon; a light source configured to: emit light at a single or plurality of wavelengths between about 200 nm to about 1100 nm and illuminate at least a portion of the biological sample; an image sensor configured to: receive at least a portion of the emitted light and convert at least the portion of the emitted light to a signal; a memory configured to store processor-executable instructions; and a processor coupled to the memory and the image sensor, wherein the instructions, when executed by the processor, cause the processor to: receive the signal from the image sensor; convert the signal into a first image representing at least the portion of the biological sample; identify a first cell type represented in the first image and associated with at least the portion of the biological sample; determine whether a quality of the biological sample is above a predefined threshold based on the identified first cell type; and when the quality is above the predefined threshold, generate an indication of an adequacy of the biological sample.

In some aspects, the techniques described herein relate to a method performed by a point-of-care device for biopsy assessment, the method including: illuminating, with a light source, at least a portion of a biological sample, wherein the illuminating occurs in a first wavelength range of a plurality of wavelengths between about 200 nm to about 1100 nm; receiving, with an image sensor, at least a portion of emitted light from the light source; converting, with the image sensor, at least the portion of the emitted light to a signal; receiving, with a processor, the signal from the image sensor; converting, with the processor, the signal into a first image; identifying, with the processor, a first cell type represented in the first image and associated with at least the portion of the biological sample; determining, with the processor, whether a quality of the biological sample is above a predefined threshold based on the identified first cell type; and when the quality is above the predefined threshold, outputting, with the processor, an indication of an adequacy of the biological sample.

In some aspects, the techniques described herein relate to a computer-readable medium including processor-executable instructions stored thereon that, when executed by a processor, cause the processor to: receive a signal from an image sensor, wherein the signal includes at least a portion of emitted light, wherein the emitted light is in a first wavelength range of a plurality of wavelengths between about 200 nm to about 1100 nm; convert the signal into a first image; identify a first cell type represented in the first image and associated with at least the portion of the biological sample; determine whether a quality of the biological sample is above a predefined threshold based on the identified first cell type; and when the quality is above the predefined threshold, output an indication of an adequacy of the biological sample.

In some aspects, the techniques described herein relate to a point-of-care device for biopsy assessment, the device including: a receptacle configured to receive a biological sample therein or thereon; a light source configured to: emit light at a single or plurality of wavelengths between about 200 nm to about 1100 nm and illuminate at least a portion of the biological sample; an image sensor configured to: receive at least a portion of the emitted light and convert at least the portion of the emitted light to a signal; a memory configured to store processor-executable instructions; and a processor coupled to the memory and the image sensor, wherein the instructions, when executed by the processor, cause the processor to: receive the signal from the image sensor; convert the signal into a first image representing at least the portion of the biological sample; identify a first cell type as a nucleated cell represented in the first image and associated with at least the portion of the biological sample, wherein a nucleic acid of the first cell type absorbs light in a first wavelength range in the plurality of wavelengths; determine whether a quality of the biological sample is above a predefined threshold based on the identified first cell type; and when the quality is above the predefined threshold, generate an indication of an adequacy and/or diagnostics of the biological sample.

In some aspects, the techniques described herein relate to a computer-implemented method for biopsy assessment, including: receiving a low-resolution image; classifying one or more regions of the low-resolution image to identify regions having one or more cells of interest; weighting the identified regions to determine a prioritized order of one or more fields of view that include one or more of the identified regions; receiving a plurality of images of the prioritized fields of view to generate a high-resolution image; classifying one or more regions of the high-resolution image to identify one or more portions having the one or more cells of interest; and outputting an estimated quantity of cells present in the one or more identified portions.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 shows a schematic of an embodiment of a point-of-care device for biopsy assessment.

FIG. 2 shows a schematic of an embodiment of a brightfield microscopy imaging subsystem of a point-of-care device for biopsy assessment.

FIG. 3 shows a schematic of an embodiment of a differential phase contrast (DPC) imaging subsystem of a point-of-care device for biopsy assessment.

FIG. 4 shows a schematic of an embodiment of a quantitative phase imaging subsystem, such as a ptychography imaging subsystem, of a point-of-care device for biopsy assessment.

FIG. 5 shows a schematic of an embodiment of a quantitative phase imaging subsystem, such as a holography imaging subsystem, of a point-of-care device for biopsy assessment.

FIG. 6 shows a schematic of an embodiment of a Raman Spectroscopy imaging subsystem of a point-of-care device for biopsy assessment.

FIG. 7 shows a schematic of an embodiment of an optical coherence tomography imaging subsystem of a point-of-care device for biopsy assessment.

FIG. 8 shows a schematic of an embodiment of a processing subsystem of a point-of-care device for biopsy assessment.

FIG. 9 shows a schematic of an embodiment of a first image acquired using an imaging subsystem of a point-of-care device for biopsy assessment.

FIG. 10 shows a flow chart of an embodiment of a method for assessing a biopsy sample using a point-of-care device.

FIG. 11 shows a flow chart of another embodiment of a method for assessing a biopsy sample using a point-of-care device.

FIG. 12 shows a flow chart of yet another embodiment of a method for assessing a biopsy sample using a point-of-care device.

FIGS. 13A-13C show various images of a slide processed according to the method of any of FIGS. 10-12.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the contemplated invention(s). Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

Point-of-care pathology services are typically limited at least because there is a shortage of pathologists and cytotechnologists. Medical facilities are often tasked with weighing the costs and benefits of sending a pathologist and/or cytotechnologist to the point-of-care (e.g., biopsy procedure) versus performing slide preparation and/or diagnostic interpretation outside of a time associated with the point-of-care.

Further, unprocessed point-of-care biological samples present technical challenges including, but not limited to, biological sample thickness and/or variability. For example, because the majority of biological samples are not simple monolayer preparations, imaging of multilayer cells can be difficult to perform, and such images may be difficult to differentiate. The highly variable nature of the biological samples also presents technical challenges for imaging since the focal length of the imaging system will typically be changed between image captures to account for the variability in the specimen.

Still further, fine needle aspirations (FNAs), fine needle biopsies (FNBs), core needle biopsies, forceps biopsies, brush samples, touch preparations, etc. include significant blood cell counts in addition to the cells of interest. There is currently not a reliable way to rapidly differentiate between nucleated cells of interest (e.g., white blood cells, bronchial cells, macrophages, etc.) and red blood cells on an imaging basis.

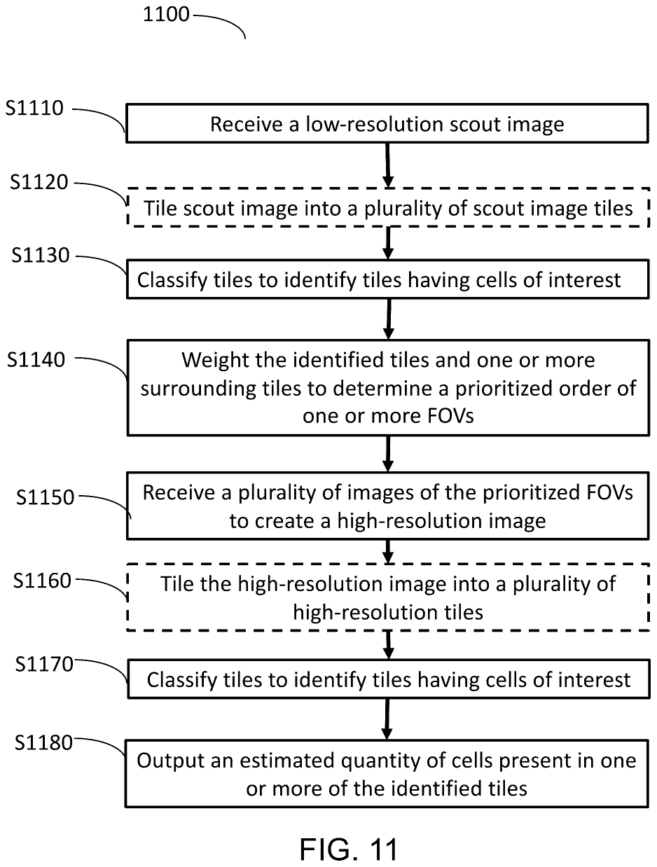

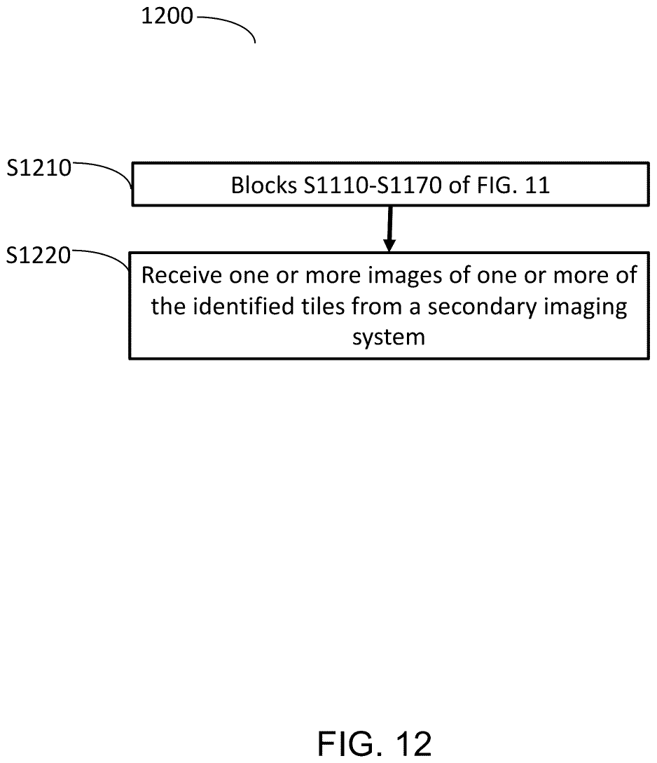

Disclosed herein are systems, devices, and methods for assessing a biological sample. The systems, devices, and methods described herein address the above technical challenges by providing a point-of-care device that can be used by physician, technician, pathologist, or other trained personnel. Biological samples can be assessed at the point-of-care or at a location remote from a patient. The systems, devices, and methods described herein further address the technical challenges presented above by effectively assessing biological samples, including being capable of differentiating nucleated cells of interest from red blood cells, irrespective of sample thickness and/or variability. The systems, devices, and methods described herein further address the technical challenges presented above by imaging and assessing biological samples with or without fixation and/or with or without staining, while also accommodating many preparation types (e.g. FNA, touch prep, brush, etc.). The multi-resolution imaging approach (as shown in FIG. 11) utilizes artificial intelligence (AI) algorithms to expedite the process of locating regions of interest and cells of interest for diagnostic purposes, enabling the system to add value at the point-of-care and in rapid fashion, for example during biopsies and other procedures. The multi-modality approach (as shown in FIG. 12) enables those initial regions of interest or cells of interest to be interrogated in greater detail (e.g., via molecular imaging using spectroscopy, autofluorescence, etc.) to determine status or disease state (e.g., cancer) and also enables processes for further diagnostic, personalized medicine, and/or research purposes.

The systems and devices described herein may be capable of imaging a biological sample and outputting an indication representing one or more aspects of the biological sample. The indication may include or represent a quality of the biological sample. For example, quality may include a number of cells represented, type(s) of cells represented, a viability of cells represented, a nuclear to cytoplasmic area ratio of one or more cells represented, one or more characteristics (e.g., morphology) of the cells represented, a number of identified cells of interest, a number of identified clusters, a presence or absence of cilia, a concentration of one or more chemicals (i.e., nicotinamide adenine dinucleotide plus hydrogen (NADH), flavin adenine dinucleotide plus hydrogen (FADH), etc.), a chemical bond and therefore molecular structure, and/or a composition of one or more identified clusters. In some embodiments the indication can include or represent an adequacy of the biological sample. For example, adequacy may include a number of nucleated cells represented and/or a number of clusters of cells represented.

In some embodiments, the indication may be provided in various forms including, but not limited to numerical, graphical, audiological, textual, and/or haptic/tactile, and the like. In general, the indication may be provided to a device or user on a display of the devices described herein and/or provided electronically to another device (e.g., a printer, a remote computer, an electronic medical or health record system, an email account, a website, etc.).

In some embodiments, the systems, devices, and methods described herein may be used to process and/or analyze a biological sample that is unstained and/or label free (i.e., not labeled with any reagents or dyes, fluorescent or otherwise), further providing an advantage of eliminating steps at the bedside before a biological sample can be assessed.

### Systems and Devices

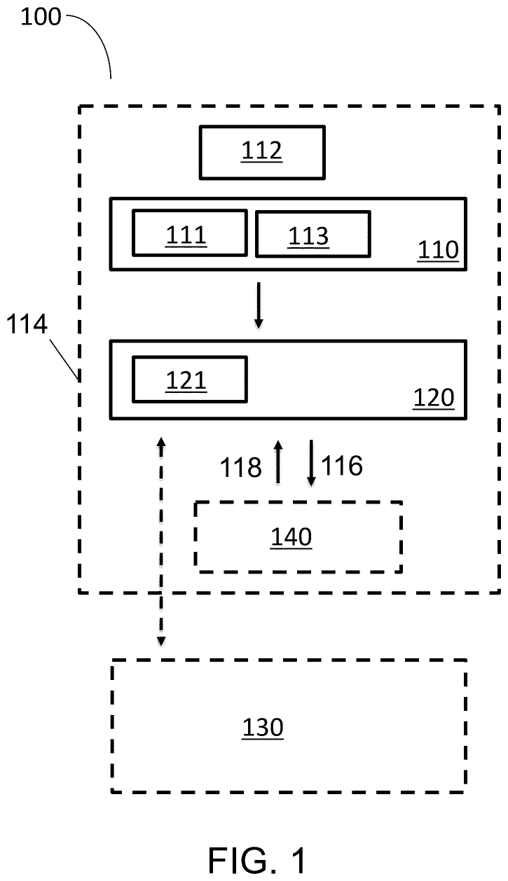

As shown in FIG. 1, a point-of-care device 100 for assessing a biological sample includes an imaging subsystem 110 and a processing subsystem 120. The device 100 may represent a system for assessing a biological sample. The device 100 may further, optionally, include or be communicatively coupled to a remote processing subsystem 130 and/or one or more remote computing devices (not shown). The imaging subsystem 110, the processing subsystem 120, the optional remote processing subsystem 130, and optional one or more remote computing devices (not shown) may communicate over an optional interface 140.

The device 100 functions to assess a biological sample in real time at the point-of-care (e.g., at a patient bedside, in an operating room, in clinic with a patient, and/or otherwise at a time of provided/delivered care). Although biopsy samples are described in detail herein, any type of biological sample may be assessed using the systems, devices, and methods described herein. For example, a biological sample may include a plant sample, human sample, veterinary sample, bacterial sample, fungal sample, or a sample from a water source. A biological sample may be cytological or histological (e.g., touch prep, FNA, frozen section, core needle, washing/body fluid, Mohs, excisional biopsy, shavings, scrapings, etc.). Bodily fluids and other materials (e.g., blood, joint aspirate, urine, semen, fecal matter, interstitial fluid, etc.) may also be analyzed using the systems, devices, and methods described herein. Further, although point-of-care devices are described herein, the device 100 may be, additionally or alternatively, used or employed in any location or use case for biological sample assessment or diagnosis.

The point-of-care device 100 may include a receptacle 112 for receiving a biological sample therein or thereon. The receptacle 112 may be fixed or movable, for example on a stage. The point-of-care device 100 may include an optional housing 114 that contains, at least in part, the receptacle 112 and the imaging subsystem 110 including at least one image detector/image sensor 111. The imaging subsystem 110 may be communicatively coupled to the processing subsystem 120 (having one or more processors 121) or processing subsystem 820 (having one or more processors 880), for example via a wired connection or wirelessly (e.g., antenna, coil, etc.). The processing subsystem 120, 820 may be at least partially contained within optional housing 114 or local or external to device 100, such that device 100 and processing subsystem 120, 820 are communicatively coupled (e.g., via an antenna, coil, or databus). One or more processors 121, 880 may represent one or more of a microprocessor, a microcontroller, or an embedded processor.

The interface 140 may receive, as an output 118 from processing subsystem 120, data or indications for display on a graphical user interface (GUI) of the interface 140. Alternatively, or additionally, interface 140 may include one or more audio, visual, or haptic indicators, such that the output 118 received from the processing subsystem 120 causes interface 140 to output an audio indication (e.g., beeping, voice command, etc. via one or more speakers), a visual indication (e.g., light sequence or flashing, visual command, etc. via one or more light sources, GUI, or the like), and/or a haptic indication (e.g., buzzing, vibration, etc. via a haptic element such as a piezo element or the like). Optional interface 140 may receive input 116 via an input element (e.g., button, slider, touchscreen, voice, etc.) or graphical user interface (GUI) that causes the interface 140 to provide output 118 for provision to processing subsystem 120. The output 118 may include various commands, data, and/or indications. For example, optional interface 140 may receive input 116 from an interface element (e.g., on a GUI), a microphone (e.g., a voice command), or the like. The interface 140 may provide the output 118 based on the particular input 116.

Device 100 may further, optionally, be communicatively coupled (e.g., antenna, coil, databus, or the like) to an optional remote processing subsystem 130 (e.g., server, workstation, etc.). Some operations of device 100 may be executed by processing subsystem 120 and some operations of device 100 may be executed by optional remote processing subsystem 130. For example, short-term or real-time processing, for example for adequacy and/or quality determinations of a biological sample, may be performed by processing subsystem 120 or processing subsystem 820, that may be local to device 100. Further, for example, long-term or latent processing, including, but not limited to diagnostic assessment, image processing that is time-intensive, etc. may be performed by optional remote processing subsystem 130. However, as can be appreciated, short-term or real time processing can also be performed by optional remote processing subsystem 130 and long-term or latent processing can also be performed by processing subsystem 120.

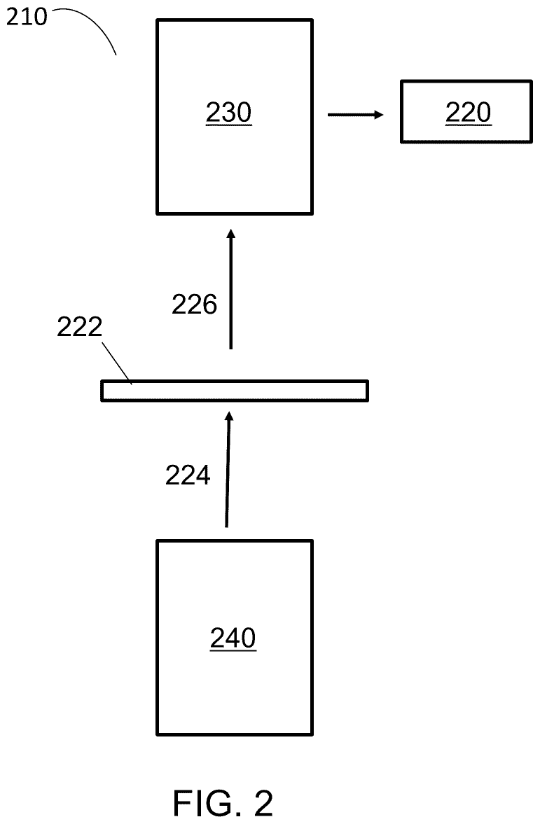

The imaging subsystem 110 of the point-of-care device 100 for assessing a biological sample may include various hardware components for imaging the biological sample. For example, the imaging subsystem 110 may optionally include one or more of: an image sensor 111 (e.g., a detector, a camera, or the like), a lens, a light source (e.g., light source 113), a condenser, a phase plate, a diffuser, a beam splitter, a mirror, a photographic plate, a filter, a grating, and/or a coupler. FIGS. 2-7 describe various imaging subsystems that may be used with any of the devices, systems, subsystems and/or methods described herein. For example, an imaging subsystem may employ transmission illumination, epi-illumination, or a combination thereof. A light source of any of the imaging systems described herein, or variations thereof, may emit light in an ultraviolet range or a deep ultraviolet range. For example, a light source can emit light at a single or plurality of wavelengths between about 200 nm to about 1100 nm. In some instances, an imaging subsystem may be equipped with a light source that is capable of emitting light at longer wavelengths (e.g., above 1100 nm), for example, to penetrate thicker biological samples, to detect autofluorescent features of cells (e.g., mitochondria, liposomes, aromatic amino acids, lipo-pigments, NADPH, flavin coenzymes, porphyrins, etc.), and/or to identify cells differing in absorption characteristics.

Although a single image sensor 111 is depicted in the device 100 of FIG. 1, any number of image sensors may be included in device 100. In addition, any of the imaging subsystems described herein (e.g., imaging subsystem 110, 210, 310, 410, 510, 610, 710) may include or be coupled to one or more image sensors 111. Although a single processor 121, 880 is depicted in the device 100 of FIG. 1 or the processing subsystem of 820, respectively, any number of processors may be included in device 100. In addition, any of the processing subsystems (e.g., processing subsystem 120, 220, 320, 420, 520, 620, 720, 820) described herein may include or be coupled to one or more processors 121, 880. Although a single light source 113 is depicted in the device 100 of FIG. 1, any number of light sources may be included in device 100. In addition, any of the imaging subsystems described herein (e.g., imaging subsystem 110, 210, 310, 410, 510, 610, 710) may include or be coupled to one or more light sources 113. Further, increasing a number of sensors, processors, etc. may enable faster speeds of analysis for point-of-care applications, for example when the patient remains in the room or on-site during the analysis.

FIG. 2 shows an embodiment of a brightfield microscopy imaging subsystem 210. Brightfield microscopy imaging subsystem 210 includes a light source 240 arranged to illuminate a sample 222. Light source 240 emits a light beam 224. At least some of the light 226 that passes through the sample 222, or is reflected or attenuated by the sample 222, is received, at least partially, by a detector 230 (e.g., an image sensor). Exemplary, non-limiting examples of image sensors include a Charge-Coupled Device (CCD), a Complementary metal-oxide-semiconductor (CMOS) device, a camera, or the like. The detector 230 can include an analog-to-digital converter (ADC) for converting the received light into a signal. The signal is received and processed by a processing subsystem 220, as will be described in further detail below. Further, the embodiment of FIG. 2 may employ one or more lenses, for example an object lens (e.g., for visible light applications) or a quartz lens (e.g., for ultraviolet light applications). In some embodiments, subsystem 210 further includes a tube lens and an objective lens.

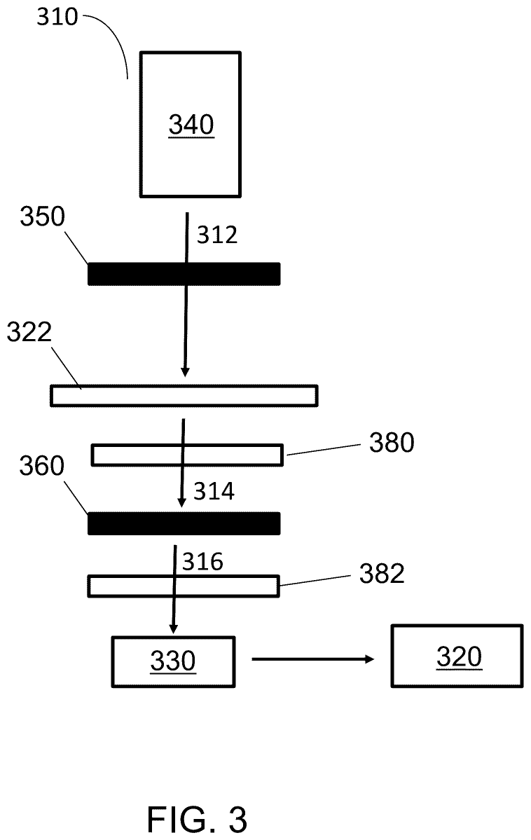

FIG. 3 shows an embodiment of a differential phase contrast (DPC) subsystem 310. As shown, the DPC subsystem 310 includes a light source 340, a condenser 350, an objective lens 380, a phase plate 360, a tube lens 382, and a detector 330. In operation of subsystem 310, a light beam 312 is emitted from light source 340. The condenser 350 concentrates light beam 312 onto a sample 322 before the light enters objective lens 380. Phase plate 360 attenuates and phase shifts the direct light 314 from objective lens 380. Light that is diffracted from sample 322 is not attenuated by phase plate 360. Tube lens 382 recombines wavefronts 316 which are received by detector 330. The detector 330 can include an analog-to-digital converter (ADC) to convert the received light into a signal. The converted signal is received and processed by a processing subsystem 320, as will be described in further detail below. Although the DPC imaging subsystem 310 is utilized in the methods described herein, one of skill in the art will appreciate that other DPC configurations may be utilized without departing from the spirit and scope of the present disclosure.

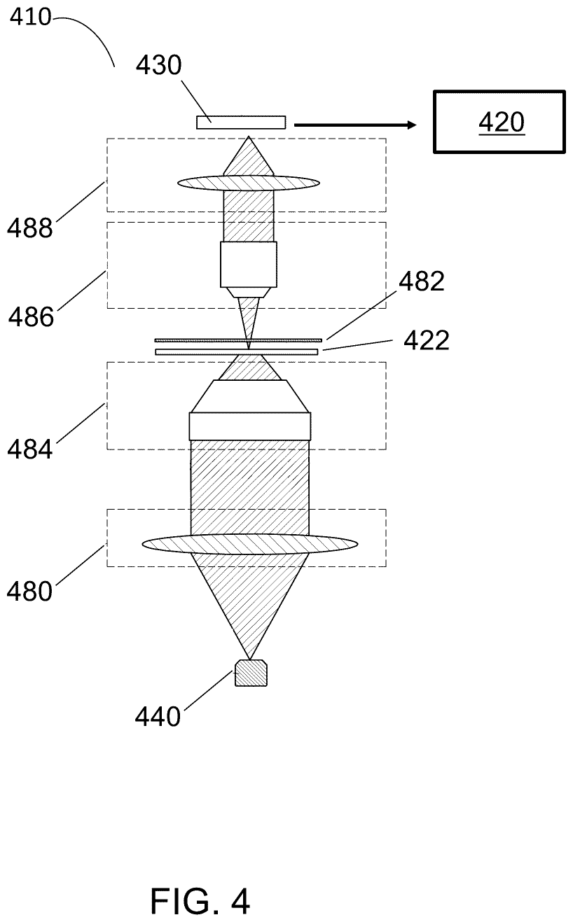

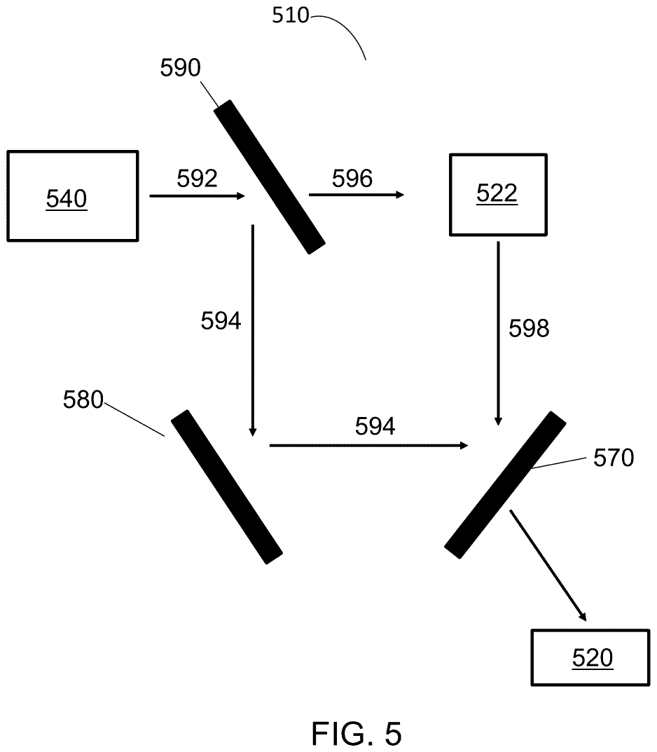

FIGS. 4-5 show various embodiments of quantitative phase imaging (QPI) subsystems 410, 510. A QPI subsystem may be useful in imaging that employs a plurality of wavelengths. For example, a QPI subsystem may be a coded ptychography imaging subsystem, a Fourier ptychography subsystem, or a holography subsystem.

FIG. 4 shows an example embodiment of a ptychography imaging subsystem 410. As shown in FIG. 4, a light source 440 (e.g., coherent light source, fiber-coupled laser, laser-diode, or similar device) produces a beam of light that may optionally pass through optional lens 480 (e.g., low numerical aperture lens, collimator lens). An optional condenser 484 may focus the illumination which then passes through a sample 422 that is placed at an offset/defocus position, for example about 20 μm to about 100 μm, relative to the focal plane perpendicular to the light source 440. A translation apparatus, e.g., a motorized stage (not shown) may move the sample 422 in the focal plane in one or more or a plurality of predefined step sizes. Prior to transmission to the detector 430, in some embodiments, the illumination may or may not pass through a diffuser 482 (e.g., or diffusing medium), to produce a unique diffraction image at the image sensor that is a combination of the translated sample and diffuser. In some embodiments, the diffuser 482 may be scotch tape, a random phase plate, styrene coated coverslip, a photolithography diffuser, or any other diffuser or diffusing medium known to one skilled in the art. Further, prior to transmission to the detector 430, in some embodiments, the illumination may or may not pass through an optional objective lens 486 and/or an optional tube lens 488. The detector 430 can include an analog-to-digital converter (ADC) to convert the received light into a signal. The converted signal is received and processed by a processing subsystem 420, as will be described in further detail below. Ptychography imaging subsystem 410 of FIG. 4 illustrates that the methods described herein can be used with a ptychography imaging subsystem. One of skill in the art will appreciate that other ptychography configurations may be utilized with the methods and devices described herein without departing from the spirit and scope of the present disclosure.

FIG. 5 shows an example embodiment of a holography imaging subsystem 510. A light source 540 (e.g., coherent light source, for example a laser) emits light beam 592, which is split into illumination beam 596 and reference beam 594 by beam splitter 590. Illumination beam 596 illuminates a sample 522. The light 598 that is reflected or refracted by sample 522 is received by photographic plate 570. The reference beam 594 is reflected by mirror 580 to mix with light 598 from sample 522 at photographic plate 570. The mixing of reference beam 594 and light 598 from the sample generates an interference pattern at photographic plate 570. Photographic plate 570 reconstructs the wavefronts which are received by processing subsystem 520, which will be described in further detail below. In some embodiments, photographic plate 570 is replaced with a detector. The holography imaging subsystem 510 of FIG. 5 illustrates that the methods described herein can be used with a holography imaging subsystem. One of skill in the art will appreciate that other holography imaging configurations may be utilized with the methods and devices described herein without departing from the spirit and scope of the present disclosure.

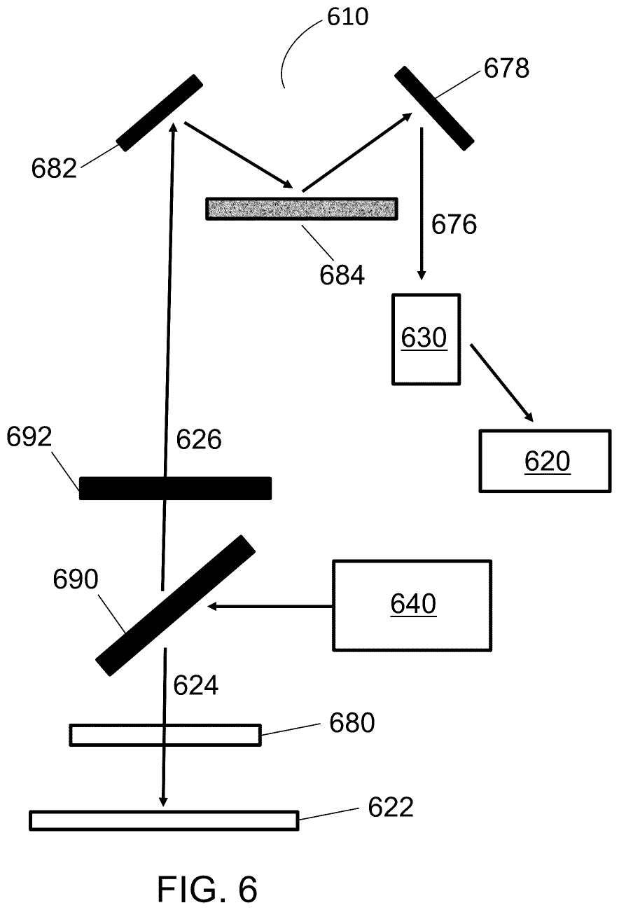

FIG. 6 shows an example embodiment of a Raman Spectroscopy imaging subsystem 610. Light source 640 (e.g., laser light) is split by beam splitter 690, such that an illumination beam 624 is focused onto a sample 622 by objective lens 680. Filter 692 filters out Raman-shifted photons 626 that are fed, for example via mirror 682, into a grating spectrometer 684. The resulting wavefronts 676 are detected by detector 630, which are processed by processing subsystem 620, which will be described in further detail below. The Raman Spectroscopy imaging subsystem 610 of FIG. 6 illustrates that the methods described herein can be used with a Raman Spectroscopy imaging subsystem. One of skill in the art will appreciate that other Ramen Spectroscopy imaging configurations may be utilized with the methods and devices described herein without departing from the spirit and scope of the present disclosure.

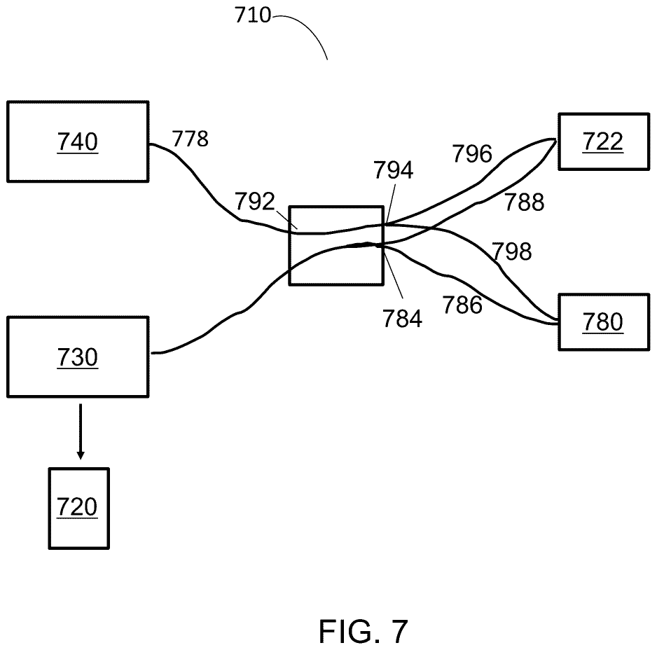

FIG. 7 shows an example embodiment of an optical coherence tomography imaging subsystem 710. Light 778 from light source 740 (e.g., low coherence light source) is split 794 by coupler 792 into sample beam 796 and reference beam 798, which each travel along a separate arm of the interferometer. Light 788 backscattered from sample 722 and light 786 reflected from mirror 780 are recombined 784 at coupler 792 to generate an interference pattern which is recorded by detector 730 and processed by processing subsystem 720, which will be described in greater detail elsewhere herein. The optical coherence tomography imaging subsystem 710 of FIG. 7 illustrates that the methods described herein can be used with an optical coherence tomography imaging subsystem. One of skill in the art will appreciate that other optical coherence tomography imaging configurations may be utilized with the methods and devices described herein without departing from the spirit and scope of the present disclosure.

A further embodiment of an imaging subsystem may be an autofluorescence microscopy subsystem. For example, an autofluorescence microscopy subsystem may include a light source, one or more optical guides, one or more band pass filters, a beam splitter, one or more lenses, and at least one detector communicatively coupled to a processing subsystem.

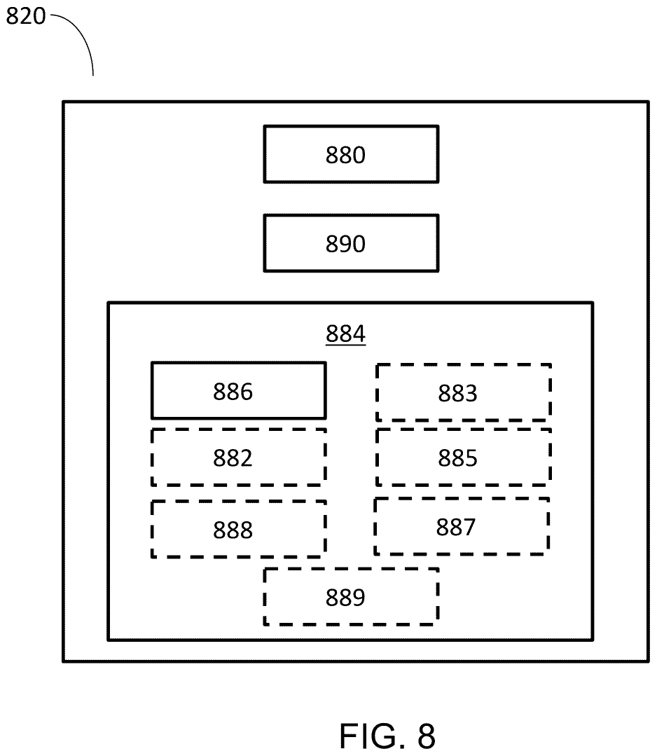

FIG. 8 shows a schematic of an embodiment of a processing subsystem 820. In some embodiments, the processing subsystem 820 may be similar to processing subsystem 120. Processing subsystem 820 may be a processing subsystem that is communicatively coupled with any of the imaging subsystems described herein (e.g., imaging subsystem 110, 210, 310, 410, 510, 610, 710). Processing subsystem 820 includes a hardware processor 880 and memory 890. Instructions stored in memory 890 may be executable by processor 880. Further, memory 890 may include an application 884 downloaded and stored thereon that includes one or more rule sets 886, optional machine learning (ML)/artificial intelligence (AI) module 882, optional computer vision (CV) module 888, optional classification AI module 883, optional scout AI module 885, optional autofocus AI module 887, and/or optional digital staining AI module 889. Processing subsystem 820 may be a local processing subsystem, as shown by processing subsystem 120 in FIG. 1, or may be at least partially implemented in a remote processing subsystem 130, as shown in FIG. 1. For example, in a variation, the one or more rule sets 886 may be stored locally and/or executed locally, while one or more of optional modules 882, 883, 885, 887, 888, 889 may be stored in a remote processing subsystem and/or executed by a remote processing subsystem. Further for example, the one or more rule sets 886 may be stored locally and/or executed locally, and one or more of optional modules 882, 883, 885, 887, 888, 889 may be stored locally and/or executed locally. Further for example, the one or more rule sets 886 may be stored on a remote processing subsystem and/or executed remotely and one or more of optional modules 882, 883, 885, 887, 888, 889 may be stored on a remote processing subsystem and/or executed remotely. In a still further variation, the one or more rule sets 886 may be stored on a remote processing subsystem and/or executed remotely, and one or more of optional modules 882, 883, 885, 887, 888, 889 may be stored locally and/or executed locally. The one or more rule sets 886 may include parameters and/or thresholds for assessing a biological sample, for example thresholds and/or parameters for determining a quality and/or adequacy of a biological sample, as described in greater detail elsewhere herein. The one or more rule sets 886 may optionally include parameters for various indications or recommendations that may be output by processing subsystem 820. Various processor executable instructions and methods will be described in further detail below.

In some embodiments, functions of the imaging subsystem and/or processing subsystem may be executed by a one or more processors, for example a microprocessor, microcontroller, or embedded processor. In some variations, the one or more rule sets, image processing, optional modules 882, 883, 885, 887, 888, 889, and the like may be performed or executed by a Digital Signal Processor (DSP), Application Specific Integrated Circuit (ASIC), Field Programmable Gate Array (FPGA), and the like.

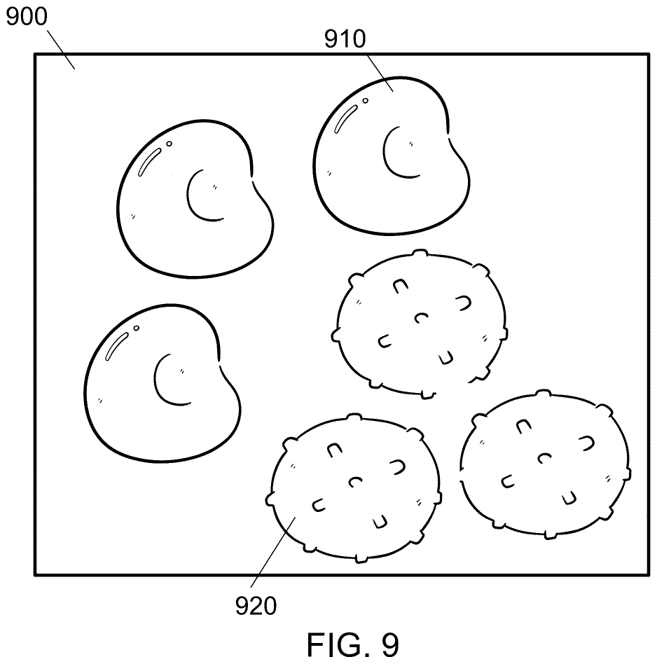

Optional ML/AI module 882 may include at least one ML model stored thereon, for example a supervised machine learning model. Exemplary, non-limiting examples of supervised machine learning models include: ResNet50, GoogleNet, and the like. As shown in FIG. 9, the ML model may be trained for object detection, such that the ML model can differentiate between a white blood cell 920 and a red blood cell 910 and/or clustered white blood cells and unclustered white blood cells in an image 900. Further, for example, optional ML/AI module 882 may differentiate between bronchial cells in various states (e.g., benign, reactive, malignant, etc.), follicular cells, clusters of cells, colloid, macrophages, neutrophils, lymphocytes, etc. (having been trained on these cell types in various states). For hematology analysis, models to differentiate between red blood cells and white blood cells, as well as neutrophils, lymphocytes, eosinophils, monocytes and basophils (having been trained on these cell types) may be used.

Optional ML/AI module 882 may output an image that has certain portions of the biological sample masked or highlighted. For example, for a biological sample from the thyroid, red blood cells may be masked in an image to enable visualization of the thyroid follicular cells, white blood cells, etc. in the image. For blood biological samples, white blood cells may be highlighted in the image to enable visualization of the white blood cells.

In one such variation, transfer learning techniques can be applied to a convolutional neural network (CNN), such as ResNet50, allowing a model trained on a large dataset to be specialized for a specific domain. For example, learned weights for one or more of the CNN input convolution layers are ‘frozen’ or fixed to leverage the learned low-level feature extraction behavior. The domain specific cytology images are then used for training (either supervised or semi-supervised) to fine-tune one or more final output layers in the network for object prediction specific to the domain.

One example is an ML model for classification of microscope images, such as optional classification AI module 883, as including certain cell types. In this instance, a plurality of images is labeled for the types of cells that are represented in the image. These images are used as training data to fine-tune a model through transfer learning.

In another example, an ML model may be used to detect objects and their associated bounding-box regions (i.e., object detection) in microscopy images. In some instances, a plurality of images is annotated by labeling individual biological structures (such as red blood cells, bronchial cells, macrophages, etc.) represented in the image, along with the bounding box for each biological structure in the image. These images are used as training data to fine-tune an object detection model, such as the Yolo model.

In another example, a transformer network (such as the Vision Transformer, ViT) is trained on a plurality of classified images to decompose each image into fixed-size patches (or flattened groups of pixels), then each patch is embedded and passed to the network Attention layers (Encoder). This architecture allows the model to learn local features as well as to reconstruct the full structure of the image.

Optional CV module 888 may include one or more algorithms that can mask one or more cell types and/or highlight one or more cell types represented in an image. The image having the unmasked cell types or highlighted cell types represented therein (e.g., based on particular wavelength(s) absorption by a particular cell type and different or no absorption by a second cell type) may be fed into optional ML/AI module 882 for object detection or diagnostic analysis to, for example, differentiate between a nucleated cell (e.g., white blood cell, tissue cell, etc.) and a red blood cell and/or clustered white blood cells and unclustered white blood cells.

Additionally, or alternatively, CV algorithms can be applied for attention detection, feature extraction, and/or image registration applications. In one such application, Oriented FAST and Rotated BRIEF (ORB) technique is used for processing of microscope images for feature detection and attention detection, providing a multi-scale, rotation invariant representation of the biologic image sample.

Optional CV module 888 can be used with or without being combined with optional ML/AI module 882 to detect features in a plurality of images of biological sample collected with different imaging characteristics (such as different wavelengths of light, etc.) and register the images so that biologic features are aligned between the images. Once aligned, further CV algorithms can be used to detect differences between the images, identifying biological structures that image differently between the different imaging techniques.

Optional classification AI module 883 executes a method including: analyzing unfocused images to determine regions, fields of view (FOVs), or tiles that: do not include biological sample; do include biological sample with substantially non-nucleated cells (red blood cells); or do include biological sample with nucleated cells. After analyzing the scout image for regions, FOVs, or tiles including nucleated cells, regions, FOVs, or tiles with the highest density or the highest probability of including interesting cells are identified for high-resolution imaging.

Optional autofocus AI module 887 computationally focuses high-resolution quantitative images post acquisition. Due to the uneven thickness of the cytology specimen on the slide, the focal distance varies significantly throughout the image. Phase wrapping and other sources of high-frequency information in the images make conventional computer vision or signal processing-based algorithms ineffective. To overcome this, the optional autofocus AI module 887 can compute a set of images to represent the sample focused on various focal distances. For each sub-region of the image, optional autofocus AI module 887 can evaluate each image in the focal stack to determine the in-focus region, FOV, or tile for the biological material in the region. In some implementations, the imaging subsystem may illuminate the biological sample with a plurality of wavelengths (either sequentially or simultaneously illuminated), providing dual-pixel disparity for each pixel in the image which can be incorporated into the optional autofocus AI module 887 as a regression loss component. The regression loss component allows for faster focusing by providing directionality and an error (distance) estimate from the correct focal distance.

Optional classification AI module 883 may execute a method including analyzing sub-regions (e.g., tiles, FOVs, regions, etc.) of an image (e.g., high resolution image) to classify the types of cells in each region. For example, a plurality of images may be labeled for the types of cells that are represented in each respective image. The plurality of images may be used as training data to fine-tune the classification AI module 883 through transfer learning. In another example, optional classification AI module 883 may be used to detect objects and their associated bounding-box regions (i.e., object detection) in images. In some instances, a plurality of images is annotated by labeling individual biological structures (such as red blood cells, bronchial cells, macrophages, etc.) represented in the image, along with the bounding box for each biological structure in the image. These images may be used as training data to fine-tune an object detection model, such as the Yolo model. In another example, a transformer network (such as the Vision Transformer, ViT) is trained on a plurality of classified images to decompose each image into fixed-size patches (or flattened groups of pixels). Then, each patch is embedded and passed to the network Attention layers (Encoder). The transformer network allows the model to learn local features as well as to reconstruct the full structure of the image.

Optional digital staining AI module 889 can execute a method including identifying cells of interest in unstained (label free) biopsy samples. When displaying regions of the biopsy sample containing identified cells, a digital staining AI module 889 can use image translation techniques to transfer domain knowledge to the unstained image to “digitally stain” the image. For example, the optional digital staining AI module 889 may include a Generative Adversarial Network or GAN-based ML model. The GAN-based ML model may be trained with a plurality of images representing the same region of the slide both unstained and stained. Through this training process, the GAN-based ML model learns how to transfer the staining information to the unstained images.

For example, in some embodiments, a processor (121, 880) may execute a method including: receiving a signal from an image sensor; converting the signal into a first image; identifying a first cell type represented in the first image and associated with at least the portion of the biological sample; and applying a digital stain to one or both of the first image or the first cell type using a digital staining module.

For example, in some embodiments, a processor (121, 880) may execute a method including: receiving a signal from an image sensor; converting the signal into a first image; and applying a digital stain to one or both of the first image or the first cell type using a digital staining module.

For example, in some embodiments, a processor (121, 880) may execute a method including: receiving a low-resolution scout image; optionally tiling the low-resolution scout image into a plurality of scout image tiles; classifying the plurality of scout image tiles (or FOV or regions if image is untiled) to identify one or more tiles (or FOV or regions if image is untiled) having cells of interest; weighting the identified one or more tiles (or FOV or regions if image is untiled) and one or more surrounding tiles (or FOV or regions if image is untiled) to determine a prioritized order of one or more FOVs; receiving a plurality of images of the prioritized FOVs to generate a high-resolution image; optionally tiling the high-resolution image into a plurality of high-resolution tiles; classifying the plurality of high-resolution tiles (or FOV or regions if image is untiled) to identify one or more tiles (or FOV or regions if image is untiled) having cells of interest; and applying a digital stain to one or both of the high-resolution image, one or more high-resolution tiles, or the one or more cells of interest using a digital staining module.

For example, in some embodiments, a processor (121, 880) may execute a method including: receiving a low-resolution scout image; optionally tiling the low-resolution scout image into a plurality of scout image tiles; classifying the plurality of scout image tiles (or FOV or regions if image is untiled) to identify one or more tiles (or FOV or regions if image is untiled) having cells of interest; weighting the identified one or more tiles (or FOV or regions if image is untiled) and one or more surrounding tiles (or FOV or regions if image is untiled) to determine a prioritized order of one or more FOVs; receiving a plurality of images of the prioritized FOVs to generate a high-resolution image; optionally tiling the high-resolution image into a plurality of high-resolution tiles; and applying a digital stain to one or both of the high-resolution image, one or more high-resolution tiles, or the one or more cells of interest using a digital staining module.

### Methods

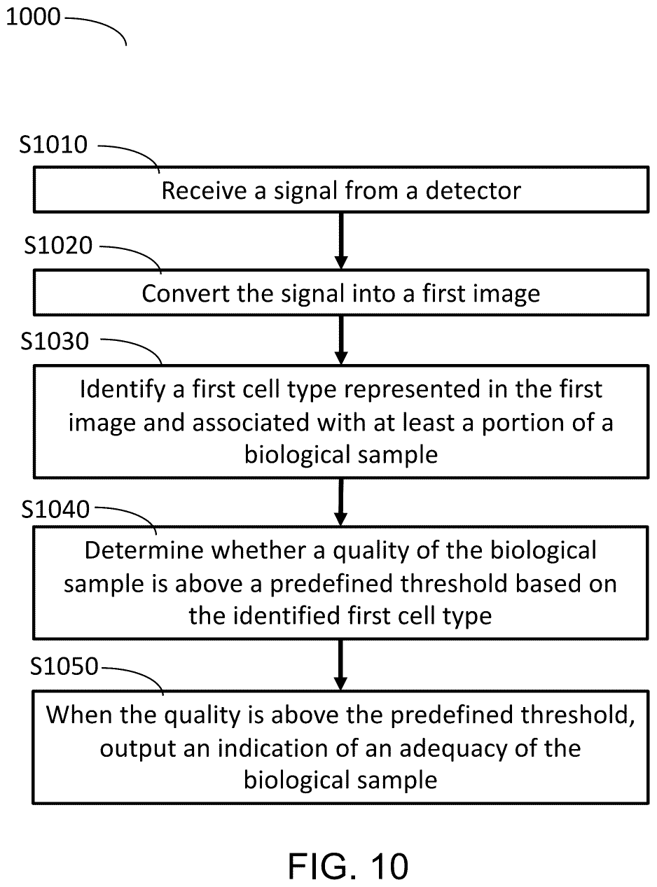

As shown in FIG. 10, one embodiment of a method 1000 for biological sample assessment, performed by one or more processors (e.g., processor 121, 880) of a processing subsystem (e.g., processing subsystem 120) or a remote processing subsystem, includes: receiving, with a processor, a signal from an image sensor at block S1010; converting, with the processor, the signal into a first image at block S1020; identifying, with the processor, a first cell type represented in the first image and associated with at least the portion of the biological sample at block S1030; determining, with the processor, whether a quality of the biological sample is above a predefined threshold based on the identified first cell type at block S1040; and when the quality is above the predefined threshold, outputting, with the processor, an indication of an adequacy of the biological sample at block S1050.

As shown in FIG. 11, an embodiment of a method 1100 for biological sample assessment, performed by one or more processors (e.g., processor 121, 880) of a processing subsystem (e.g., processing subsystem 120, 820) or a remote processing subsystem, includes: receiving a low-resolution scout image at block S1110; optionally tiling the low-resolution scout image into a plurality of scout image tiles at block S1120; classifying the plurality of scout image tiles (or FOV or regions if image is untiled) to identify one or more tiles (or FOV or regions if image is untiled) having cells of interest at block S1130; weighting the identified one or more tiles (or FOV or regions if image is untiled) and one or more surrounding tiles (or FOV or regions if image is untiled) to determine a prioritized order of one or more FOVs at block S1140; receiving a plurality of images of the prioritized FOVs to generate a high-resolution image at block S1150; optionally tiling the high-resolution image into a plurality of high-resolution tiles at block S1160; classifying the plurality of high-resolution tiles (or FOV or regions if image is untiled) to identify one or more tiles (or FOV or regions if image is untiled) having cells of interest at block S1170; and outputting an estimated quantity of cells present in one or more of the identified tiles (or FOV or regions if image is untiled) at block S1180.

As shown in FIG. 12, an embodiment of a method 1200 for biological sample assessment, performed by one or more processors (e.g., processor 121, 880) of a processing subsystem (e.g., processing subsystem 120, 820) or a remote processing subsystem, includes: blocks S1110-S1170 of FIG. 11 at block S1210, as described above; and receiving one or more images of one or more of the identified tiles from a secondary imaging system at block S1220.

The methods 1000, 1100, 1200 of FIGS. 10-12 function to analyze biological samples, for example biopsy specimens. The methods 1000, 1100, 1200 are used for cytopathology, but can additionally, or alternatively, be used for any suitable applications, clinical or otherwise. The methods 1000, 1100, 1200 can be configured and/or adapted to function for the analysis of any suitable biological specimen preparation, including plant, bacterial, human, veterinary, fungal, water, cytological, histological, bodily fluids, and the like.

Blocks S1010-S1050, blocks S1110-S1180, and blocks S1210-S1220 may be performed by one or more processors (e.g., processor 121, 880) of a processing subsystem, for example any of the processing subsystems described herein (e.g., processing subsystem 120, 220, 320, 420, 520, 620, 720). Alternatively, or additionally, blocks S1010-S1050 blocks S1110-S1180, and blocks S1210-S1220 may be performed by a processor of a remote processing subsystem 130. As described elsewhere herein, the methods 1000, 1100, 1200 of FIGS. 10-12 may be executed by a processing subsystem that is, in part or wholly, located in a local computing device and/or remote processing subsystem. For example, components of processing subsystem may be co-located or distributed.

In some variations of methods 1000, 1100, 1200, at least a portion of a biological sample is illuminated sequentially (i.e., time-based multiplexing) at a first wavelength or in a first wavelength range and then at a second wavelength or in a second wavelength range. For example, the first wavelength or wavelength range may be about 200 nm to about 300 nm. Further for example, the second wavelength or wavelength range may be about 380 nm to about 460 nm. Alternatively, the first wavelength or wavelength range may about 380 nm to about 460 nm and the second wavelength or wavelength range may be about 200 nm to about 300 nm. Time-based multiplexing may be advantageous for achieving high resolution images and/or may be advantageous in imaging subsystems that employ phase imaging.

In some instances of methods 1000, 1100, 1200, at least a portion of the biological sample is illuminated substantially simultaneously (i.e., frequency-based multiplexing) at a first wavelength or in a first wavelength range and at a second wavelength or in a second wavelength range. For example, a light source of any of the imaging subsystems described herein (e.g., imaging subsystem 110, 210, 310, 410, 510, 610, 710) may emit light at the first and second wavelengths or in the first and second wavelength regions or two or more light sources may be used to emit light at the first and second wavelengths or in the first and second wavelength regions. Frequency-based multiplexing may be advantageous for processes or applications that may benefit from faster acquisition times.

In some instances, any of the imaging subsystems described herein (e.g., imaging subsystem 110, 210, 310, 410, 510, 610, 710) may be arranged or equipped to image a first field-of-view (FOV), a second FOV, a third FOV . . . nth FOV. For example, FOVs may be “streamed” in real-time to a processing subsystem or remote processing subsystem for analysis. Streaming of data may be used to parallelize processes for efficiency. For example, after an imaging subsystem images a first FOV, the image processing or reconstruction may start while the imaging subsystem is imaging the second FOV.

In time-based multiplexing, a first FOV may be illuminated with a light source of an imaging subsystem at a first wavelength or in a first wavelength range, then the first FOV may be illuminated with the light source at a second wavelength or in a second wavelength range, which can be repeated for a number of FOVs. Alternatively, in time-based multiplexing, all, substantially all, or a subset of the FOVs may be illuminated with a light source of an imaging subsystem at a first wavelength or in a first wavelength range and then all, substantially all, or a subset of the FOVs may be illuminated with the light source at a second wavelength or in a second wavelength range.

In some instances, in frequency-based multiplexing, a first FOV may be illuminated with one or more light sources of an imaging subsystem at a first wavelength or in a first wavelength range and at a second wavelength or in a second wavelength range simultaneously, which can be repeated for a number of FOVs. Alternatively, in frequency-based multiplexing, all, substantially all, or a subset of the FOVs may be illuminated with one or more light sources of an imaging subsystem at a first wavelength or in a first wavelength range and at a second wavelength or in a second wavelength range.

Alternatively, a whole slide or biological sample may be imaged, instead of FOV by FOV, by an imaging subsystem employing one or more light sources and at one or more wavelengths or in one or more wavelength regions, using time-based or frequency-based illumination.

Light emitted, attenuated, refracted, scattered, or otherwise from the biological sample is received by a detector of any of the imaging subsystems described here (e.g., imaging subsystem 110, 210, 310, 410, 510, 610, 710) and converted to a signal, for example using an ADC. The signal is received by a processor of a processing subsystem and/or a remote processing subsystem.

Returning to FIG. 10, an embodiment of a method 1000 for biological sample assessment includes block S1010, which recites receiving a signal from a detector. Block S1010 functions to share data between an imaging subsystem, including a detector (e.g., image sensor), and a processing subsystem (e.g., processing subsystem 120). The data may be transmitted from the imaging subsystem to the processing subsystem via a wireless connection (e.g., antenna, coil, etc.) or via a wired connection. The data transmitted between the imaging subsystem and the processing subsystem may be streamed in real-time or stored after image acquisition and processed thereafter.

As shown in FIG. 10, an embodiment of a method 1000 for biological sample assessment includes block S1020, which recites converting the signal into an image. For example, the processor (e.g., processor 121, 880) may perform one or more operations to convert the raw data from the detector or sensor (e.g., sensor 111) of an imaging subsystem into an image. For example, the processing subsystem 120 may perform various pre-processing operations on the signal from the sensor 111, such as adjusting the brightness and contrast of the image, removing noise, and/or correcting for lens distortion. In some instances, the processing subsystem 120 may further perform edge detection and/or color filtering to extract meaningful information from the signal and generate a two-dimensional representation of the image. Further, the processing subsystem 120 may output the processed image data in a standard image format, such as JPEG, PNG or SVS, that can be displayed on a display, saved to storage, and/or transmitted to a processing subsystem for further processing.

As shown in FIG. 10, an embodiment of a method 1000 for biological sample assessment includes block S1030, which recites identifying a first cell type represented in the first image and associated with at least the portion of the biological sample. The identification of the first cell type or one or more cell types may be performed by processing subsystem. For example, a processor 880 of processing subsystem, optional ML/AI module 882, and/or optional CV module 888 may perform the identification. The identification of the first cell type may be based on absorption of one or more wavelengths by a nucleic acid (e.g., DNA and/or RNA) highlighting the nucleus in the first cell type. For example, the first cell type may be a nucleated cell. Absorption can occur at a first wavelength or in a first wavelength range, for example between about 200 nm to about 300 nm, about 225 nm to about 280 nm, about 250 nm to about 270 nm, about 230 nm to about 280 nm, about 260 nm to about 270 nm, or substantially 265 nm. Alternatively, the identification of the first cell type may be based on absorption of one or more wavelengths by hemoglobin in the first cell type. For example, the first cell type can be a red blood cell. A red blood cell may absorb light at a first wavelength or in a first wavelength range between about 380 nm to about 460 nm, about 390 nm to about 460 nm, about 400 nm to about 460 nm, about 410 nm to about 460 nm, about 420 nm to about 460 nm, about 430 nm to about 460 nm, about 440 nm to about 460 nm, or substantially 450 nm. In some variations, a second cell type is identified in the image and associated with the biological sample. The second cell type may be different than the first cell type. In an embodiment, the first cell type is a nucleated cell, and the second cell type is an anucleated cell type (e.g., red blood cell). As described elsewhere herein, the first cell type and second cell type may be illuminated sequentially or simultaneously by a light source of an imaging subsystem. Similarly, the first cell type and second cell type may be identified simultaneously or sequentially by a processing subsystem.

In some instances, the processing subsystem 120 (e.g., processor 121, 880) may mask or remove one or more cell types in an image to reduce portions of the image being processed and/or differentiate cell types represented in the image in the identification at block S1030. Such a reduction in image portions may allow the identifying of the first cell type to occur in an improved and/or faster manner than would otherwise occur without performing the masking and/or removing of one or more cell types. Masking and/or removing one or more cell types may include using optional ML/AI module 882 and/or optional CV module 888 to enable further processing of the image. Removing or masking may include: digitally subtracting a cell type from the image. Digital subtraction may be performed or executed based on one or more of: an absorption of one or more of the plurality of wavelengths by a cell type or one or more cells in the image, a refractive index of the cell type or one or more cells in the image, or a dry mass calculation of the cell type or one or more cells in the image. For example, refractive index is the velocity of light in a vacuum divided by the velocity of light in a substance. When analyzing monolayer samples, refractive index can be determined for the cell or subcomponents of a cell and used to remove or mask one or more cell types.

In some embodiments, a difference image can be generated. Images at different wavelengths can be digitally subtracted to obtain the difference image. One or more cell types may be determined, identified, or otherwise differentiated in the difference image, using optional ML/AI module 882 and/or a processor 880, 121. For example, one or more processors 121, 880 may be configured to receive a multi-wavelength image; and digitally subtract cells at or below a predefined threshold. For example, a light source emitting a first wavelength (e.g., 450 nm) may be used to identify one or more first cell types (e.g., red blood cells) in the sample. The light source may further illuminate the sample at a second wavelength. A cell type in the sample that varies significantly in absorption between the first and second wavelengths can then be digitally subtracted to remove the cell type from the image. In some embodiments, the digital subtraction may be manually activated or deactivated depending on a user or a type of image or sample, or automatically activated or deactivated in order to digitally subtract particular cell types and/or to digitally subtract cells at or below the predefined threshold.

Identifying a cell type may include, additionally or alternatively, generating a digital highlight to overlay a nucleic acid of the cell type in the image using optional ML/AI module and/or optional CV module. The processing subsystem 120, 820 (e.g., processor 121, 880) may generate a digital highlight to overlay a nucleic acid of a cell type. Such highlighting in image portions may allow the identifying of the first cell type to occur in an improved and/or faster manner than would otherwise occur without performing the digital highlighting of one or more cell types. Digitally highlighting one or more cell types may include using optional ML/AI module and/or optional CV module to enable further processing of the image. Digital highlighting may be based on one or more of: an absorption of one or more of the plurality of wavelengths by the cell, a refractive index of the cell, or a dry mass calculation of the cell. In an example, once the nucleated cells are highlighted, an AI/ML model (with or without additional CV algorithms) identifies and classifies the nucleated cells. Once classified, the number of each identified cell type (e.g., absolute numbers or various counting heuristics to account for clumps of cells) is computed. These cell counts or cell count ranges are displayed or output to the proceduralist and/or pathologist to determine sample adequacy. In some embodiments, adequacy may be automatically or autonomously determined, for example based on predefined thresholds set by a manufacturer, physician, clinic, standard, etc.

In some embodiments, a processor (e.g., processor 121, 880) of a processing subsystem or a remote processing subsystem may execute one or more rule sets for digitally or optically sectioning an image. Digital or optical sectioning may enable, for example, further processing of a biological sample that includes multiple layers and/or that is thicker. An advantage of digital or optical section is that a three-dimensional biological specimen can be imaged and digitally/optically sectioned without manually slicing the sample and mounting the sample. Enabling the specimen to remain intact and in 3D enables assessments and/or diagnoses based on architectural, structural, and/or histological details.

As shown in FIG. 10, an embodiment of a method 1000 for biological sample assessment includes blocks S1040 and S1050, which recite determining whether a quality of the biological sample is above a predefined threshold based on the identified first cell type; and when the quality is above the predefined threshold, outputting an indication of an adequacy of the biological sample.

For example, quality may include a number of cells represented, such that processing subsystem (e.g., processor 121, 880) identifies a number of cells by calculating a number of regions in an image that have a predefined pixel intensity relative to a background of the image or relative to n nearest neighbor pixels. A predefined threshold for a number of cells may be above about 100 cells; between about 20 cells to about 100 cells; between about 50 cells to about 150 cells; between about 50 cells to about 100 cells; greater than about 100 cells; between about 100 cells and 1,000 cells; between about 500 cells to about 1,000 cells; between about 500 cells and about 1,500 cells; greater than about 1,000 cells; etc. In some embodiments, a predefined threshold may be configured by a user, an institution, a manufacturer, for example, depending on a type of biopsy sample, a pathologist preference, a type of institution, etc. For example, some tests that can be run on samples may have higher cell count prerequisites (e.g., greater than 100 bronchial cells for a first type of test; greater than 1,000 bronchial cells for a second type of test, etc.).

Further for example, a quality may include a type(s) of cells represented, such that processing subsystem (e.g., processor 121, 880) determines a first cell type based on absorption of emitted light from a light source of an imaging subsystem in a particular wavelength range. As described elsewhere herein, nucleated cells (e.g., white blood cells) versus anucleated cells may absorb light at different wavelengths or in different wavelength regions, for example based on the presence or absence of nucleic acids (i.e., nucleus), respectively. A predefined threshold for a type of cells in a biological sample may be between about 20% to about 100% white blood cells (WBCs), between about 40% to about 100% WBCs, about 60% to about 100% WBCs, about 80% to about 100% WBCs, etc. A predefined threshold for a type of cells in a biological sample may be between about 20% to about 100% red blood cells (RBCs), between about 40% to about 100% RBCs, about 60% to about 100% RBCs, about 80% to about 100% RBCs, etc.

Quality may include a viability of cells represented. For example, when smearing a sample, there may be crushed artifacts. In other words, when smearing, cells are commonly crushed or broken and can have their intracellular contents smeared across the slide and/or can appear stringy. In some embodiments, processing subsystem (e.g., processor 121, 880) may be configured to determine a viability of the cells in the sample. For example, the processing subsystems described herein can be configured to determine a percent of cells that are intact (e.g., based on morphology, viability staining, etc.); and output a quality of the viability of the cells. Alternatively, the processing subsystems described herein may output a quality indicator when the percent of viable cells is above a predefined threshold. For example, a predefined threshold for a viability of cells may be a viability of greater than about 80%, greater than about 90%, greater than about 95%, or between about 70% to about 100%, about 80% to about 100%, about 90% to about 100%, etc.

Quality may include a nuclear to cytoplasmic area ratio of one or more cells represented. For example, processing subsystem (e.g., processor 121, 880) may determine a nuclear area of one or more cells represented based on an absorption of one or more wavelengths of light by a nucleic acid in the nucleus versus an overall area of the cell based on, for example, object detection or edge detection to delineate an outline of the one or more cells.

Quality may include one or more characteristics (e.g., morphology) of the cell represented. For example, processing subsystem (e.g., processor 121, 880) may determine one or more characteristics of one or more cells represented in the image. For example, a characteristic may be a morphology of a cell. A morphology may be a smooth cellular surface (e.g., lymphocyte), a stellate cellular surface (e.g., macrophage), one or more granules present (e.g., eosinophils, neutrophils, etc.), a disc shape (e.g., red blood cell), etc.

Quality may include a number of identified clusters, and/or a composition of one or more identified clusters represented in an image from a biological sample. For example, processing subsystem (e.g., processor 121, 880) may determine a number of cells in the image, for example, based on absorption at a particular wavelength or in a particular wavelength range. Processing subsystem (e.g., processor) may further determine whether one or more cells are aggregated or clustered based on a determined distance between each identified cell or nuclear region based on the light absorption.

Quality may include determining a presence or absence of cilia. For example, processing subsystem (e.g., processor 121, 880) may identify a morphology of one or more cells in a sample. The processing subsystems described herein may execute an algorithm or AI model (e.g., based on one or more rule sets 886; optional CV module 888; and/or optional ML/AI module 882) for pattern matching or object identification to determine a presence or absence of cilia on one or more cells in a sample.

Quality may include determining a presence or absence or a concentration of one or more chemicals (i.e., NADH, FADH, etc.) and/or a presence or absence of a chemical bond (i.e., a molecular structure), etc. For example, to determine a presence or absence of a concentration of one or more chemicals, a light source of any of the imaging subsystems described herein, and variations thereof, may excite at least a portion of the biological sample at a first wavelength or in a first wavelength range of a plurality of wavelengths. Light emitted, attenuated, refracted, scattered, or otherwise reflected from the biological sample is received by a detector and converted to a signal, for example using an ADC. The detector may be, for example, a component of an imaging subsystem, such as any of the imaging subsystems described elsewhere herein (e.g., imaging subsystem 110, 210, 310, 410, 510, 610, 710). A processing subsystem (e.g., processor 121, 880) may receive the signal and determine, based on the received signal and the known excitation wavelength, the molecular makeup or molecules that are present in the biological sample. In some embodiments, the determining step is further, or alternatively, based on performing a second harmonic generation or performing frequency doubling, in which photons interacting with a nonlinear material are effectively combined to form new photons having twice the frequency of the initial photons.

For example, to determine a presence or absence of a chemical bond to infer a presence or absence of a molecule, Raman Spectroscopy can be used (shown in FIG. 6). Molecules have three types of motion: translational, rotational, and vibrational. Translational motion includes molecules moving from one position to another. Rotational motion includes entire molecules rotating or the internal parts of a molecule rotating with respect to one another. Vibrational motion includes bond movement between atoms within a molecule. Raman Spectroscopy can use light scatter from molecular vibrations to characterize a molecule. In some embodiments, a light source of any of the imaging subsystems described herein, and variations thereof, may excite at least a portion of the biological sample at a first wavelength (e.g., in the visible, infrared, or ultraviolet range). Light scattered by the biological sample, having been shifted up or down by molecular vibrations in the sample, is received by a detector and converted to a signal, for example using an ADC. The detector may be, for example, a component of imaging subsystem 610. A processing subsystem (e.g., processor 121, 880) may receive the signal and determine, based on the received signal and the Raman Shift of the scattered light, the molecular or molecules that are present in the biological sample.

The indication can be an adequacy of the biological sample. For example, determining whether a biological sample is adequate may include determining that a number of nucleated cells represented and/or a number of clusters of cells represented in the sample are above a predefined threshold. In one non-limiting example, a predefined threshold may include a cell number equal to or above about 60 cells (i.e., based on Bethesda guidelines for thyroid FNA). In some variations, a predefined threshold may be above about 100 cells, for example for applications employing molecular testing, biomarker testing, etc. In some embodiments, a predefined threshold may include a cluster number equal to or above about 6 clusters of at least 10 nucleated cells. In another non-limiting example, a predefined threshold may be based on a baseline percentage of white blood cells for a healthy individual. For example, when the number of nucleated cells in the biological sample is above the predefined threshold (i.e., baseline percentage of white blood cells for a healthy individual), the biological sample is considered to be adequate.

As described elsewhere herein, outputting an indication of adequacy may include causing the processor (e.g., processor 121, 880) to output an audio, haptic, or visual indication to an interface when adequacy meets or is above the predefined threshold and/or outputting an audio, haptic, or visual indication to an interface when adequacy is below the threshold. Additionally, or alternatively, outputting an indication of adequacy may include causing the processor to output an updated GUI to an interface that indicates the adequacy determination.

In some implementations of the method 1000, at least a portion of a biological sample is illuminated with a light source (e.g., light source 113). For example, the light source 113 may be a component of an imaging subsystem, such as any of the imaging subsystems described elsewhere herein (e.g., imaging subsystem 110, 210, 310, 410, 510, 610, 710). A light source of any of the imaging subsystems described herein, and variations thereof, may illuminate at least a portion of the biological sample at a first wavelength or in a first wavelength range of a plurality of wavelengths between about 200 nm to about 1100 nm. Light emitted, attenuated, refracted, scattered, or otherwise from the biological sample is received by a detector and converted to a signal, for example using an ADC. The detector may be, for example, a component of an imaging subsystem, such as any of the imaging subsystems described elsewhere herein (e.g., imaging subsystem 110, 210, 310, 410, 510, 610, 710).

The method may optionally include causing the processor to stitch together one or more FOV, all FOV, substantially all FOV, or a subset of the FOV before or after the outputting the indication.

In some variations, receiving the signal, identifying a cell type, and determining a quality of the biological sample for a first FOV are executed by a processing subsystem while a second field of view is imaged by the imaging subsystem. Alternatively, receiving, identifying, and determining for a first FOV may be executed by a processing subsystem before a second field of view is imaged by the imaging subsystem. Still further, in some instances, receiving, identifying, and determining is executed for a first field of view of a plurality of fields of view by the processing subsystem after a remainder of the plurality of fields of view is imaged by the imaging subsystem.

A method of assessing a biological sample may include imaging, using an imaging subsystem, a plurality of FOVs at a first wavelength or in a first wavelength region; and prioritizing, using a processing subsystem, one or more of the FOV of the plurality of FOVs based on the imaging at the first wavelength or in the first wavelength range. Prioritization (e.g., scoring, ranking, etc.) may be based on a number or cells, type of cells, percentage of FOV containing cells, likelihood of FOVs containing cells of interest, and/or clustering of cells in the plurality of FOVs. For example, a FOV may be scored for a likelihood of containing a cell of interest and the FOVs may be prioritized based on the score. In some variations, prioritization may be based on: types of cells detected and/or percentage of FOV likely containing cells of interest, with a highest score given to those FOVs with a sample of both clustered cells of interest and individual cells of interest near the clusters. The one or more prioritized FOVs may be used for further processing as described elsewhere herein, for example in FIG. 10, or may be further imaged at a second wavelength or in a second wavelength range. The first pass, imaging at the first wavelength or in the first wavelength range, may be performed at a lower resolution than the second pass, imaging at the second wavelength or in the second wavelength range. Alternatively, the first and second imaging passes may be at a high resolution or performed by a high-resolution imaging subsystem.

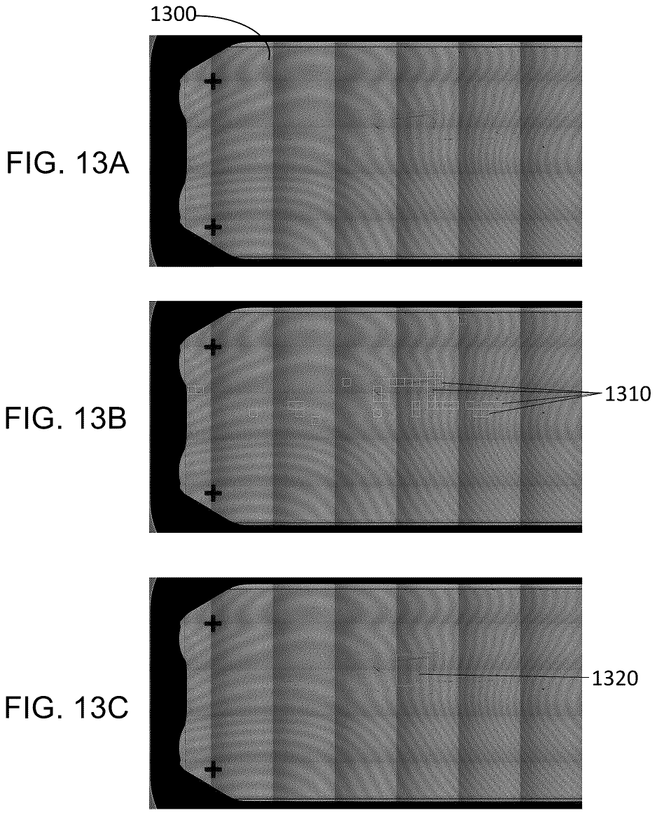

Turning now to FIG. 11. An embodiment of a method 1100 for biological sample assessment includes block S1110, which recites receiving a low-resolution image, also described herein as a scout image. Any of the imaging subsystems described herein (e.g., imaging subsystem 110, 210, 310, 410, 510, 610, 710) may be used to acquire the low-resolution image (e.g., brightfield image, diffraction image, etc.). In some embodiments, a low-resolution image may be acquired by acquiring low resolution images of one or more portions or FOVs, each portion or FOV, a plurality of portions or FOVs, etc. of a slide and then stitching the portions or FOVs together. For example, the method may optionally include causing the processor to stitch together one or more FOV, all FOV, substantially all FOV, or a subset of the FOV. For example, the image 1300 shown in FIG. 13A is an example of a low-resolution image of a slide. The sample present on the slide may be stained, unstained, fixed, unfixed, processed, unprocessed, etc.

As shown in FIG. 11, an embodiment of a method 1100 for biological sample assessment includes optional block S1120, which recites tiling the low-resolution scout image into a plurality of scout image tiles. In some embodiments, tiling includes subdividing the low-resolution image in optical space and, optionally, rendering one or more sections of tiles separately. Optionally, in some embodiments, the tiled image may be output to a user. In some embodiments, the tiles are each a polygon (e.g., square, rectangle, etc.) of equal size.

As shown in FIG. 11, an embodiment of a method 1100 for biological sample assessment includes block S1130, which recites classifying the plurality of scout image tiles (or FOV or regions if image is untiled) to identify one or more tiles (or FOV or regions if image is untiled) having cells of interest. In some embodiments, classifying includes executing an AI classification model using optional ML/AI module 882 and/or optional scout AI module 885. Optional scout AI module 885 is trained to determine which tiles (or FOV or regions if image is untiled) of the plurality of tiles include one or more cells of interest (e.g., nucleated cells) versus background (e.g., portion of slide with few or no cells) or tiles (or FOV or regions if image is untiled) that include cells of reduced or limited interest (e.g., anucleated cells). For example, the image shown in FIG. 13B is an example of a tiled low-resolution image having a subset of the tiles 1310 identified as including cells of interest. In some embodiments, classification optionally further includes assigning a confidence level to one or more classified tiles (or FOV or regions if image is untiled) of the plurality of tiles. When the confidence level for a classified tile (or FOV or regions if image is untiled) meets or exceeds a predefined threshold, the tile may be identified or output as having one or more cells of interest.

As shown in FIG. 11, an embodiment of a method 1100 for biological sample assessment includes block S1140, which recites weighting the identified one or more tiles and one or more surrounding tiles to determine a prioritized order of one or more FOVs. In some embodiments, weighting may include using the confidence score from block S1130 for one or more identified tiles which is based on a likelihood of a tile having one or more cells of interest. The weighting may be executed by processor 121 or processor 880 using one or more rule sets 886. The output may include one or more contiguous tiles combined into one or more FOVs 1320 based on the weighting, as shown in FIG. 13C. One or more algorithms may be used to compute a score for the one or more FOVs including one or more contiguous tiles. In other words, the algorithm prioritizes or scores FOVs that include the tiles having a higher model confidence, meaning higher likelihood of having one or more cells of interest. Optionally, one or more algorithms may also determine which location to capture for an initial FOV, identify where to take subsequent FOVs, and order the FOVs for capture.

In some embodiments, prioritization (e.g., scoring, ranking, etc.) may be based on a number or cells, type of cells, percentage of FOV containing cells, likelihood of FOVs containing cells of interest, and/or clustering of cells in the plurality of FOVs. For example, a FOV may be scored for a likelihood of containing a cell of interest and the FOVs may be prioritized based on the score. In some variations, prioritization may be based on: types of cells detected and/or percentage of FOV likely containing cells of interest, with a highest score given to those FOVs with a sample of both clustered cells of interest and individual cells of interest near the clusters. The one or more prioritized FOVs may be used for further processing as described elsewhere herein, for example in FIGS. 10-12, or may be further imaged at a second wavelength or in a second wavelength range. The first pass, imaging at the first wavelength or in the first wavelength range, may be performed at a lower resolution than the second pass, imaging at the second wavelength or in the second wavelength range. Alternatively, the first and second imaging passes may be at a high resolution or performed by a high-resolution imaging subsystem.

As shown in FIG. 11, an embodiment of a method 1100 for biological sample assessment includes block S1150, which recites receiving a plurality of images of the prioritized FOVs to generate a high-resolution image. For example, any of the imaging subsystems described herein (e.g., imaging subsystem 110, 210, 310, 410, 510, 610, 710) may be used to acquire the plurality of images. The plurality of images may be acquired in a predefined pattern based on the prioritization of FOVs. In some embodiments, the high-resolution image is propagated to numerous focal planes to be able to later select the optimal focal plane.

As shown in FIG. 11, an embodiment of a method 1100 for biological sample assessment includes optional block S1160, which recites tiling the high-resolution image into a plurality of high-resolution tiles. In some embodiments, tiling includes subdividing the high-resolution image in optical space and optionally rendering one or more sections of tiles separately. Optionally, in some embodiments, the tiled high-resolution image may be output to a user. In some embodiments, the tiles are each a polygon (e.g., square, rectangle, etc.) of equal size. Optionally, the high-resolution image may be autofocused before or after tiling. The autofocusing may be performed by autofocus AI module 887. In some embodiments, autofocusing may be executed for the high-resolution image or one or more tiles to determine an optimal focal plane. The autofocus AI module 887 may execute an AI model that is trained on a library of manually focused images. In some embodiments, an optional normalization process may also be executed.

As shown in FIG. 11, an embodiment of a method 1100 for biological sample assessment includes block S1170, which recites classifying the plurality of high-resolution tiles to identify one or more tiles having cells of interest. For example, classification AI module 883 may classify one or more high-resolution tiles (or FOV or regions if image is untiled), optionally after autofocusing, to identify one or more high-resolution tiles (or FOV or regions if image is untiled) having cells of interest (e.g., benign nucleated cell, malignant cell, red blood cell, lymphocyte, macrophage, histiocyte, etc.).

As shown in FIG. 11, an embodiment of a method 1100 for biological sample assessment includes block S1180, which recites outputting an estimated quantity of cells present in one or more of the identified tiles (or FOV or regions if image is untiled). In some embodiments, the model may further output an estimated quantity range for one or more identified tiles (or FOV or regions if image is untiled). The estimated quantity may be determined using one or more rule sets 886 for analyzing the identified one or more high-resolution tiles (or FOV or regions if image is untiled) having the cells of interest.

In some embodiments, any of blocks S1110-S1180 may run in parallel, for example as a pipeline, as the system images the previously identified and prioritized FOVs.

In some embodiments, method 1100 may further include outputting tile confidence scores, for example for a type of cell, arranged from highest confidence to lowest confidence, or lowest confidence to highest confidence.

In some embodiments, any of methods 1000, 1100, 1200 for determining a cell type of interest may include receiving a default cell type based on a type of procedure (e.g., based on clinical settings, manufacturer settings, clinician settings, predefined standards, etc.). In some embodiments, the system may also output (e.g., based on user request or automatically) confidence scores or data for other cell types that are not the default cell type based on a type of procedure.

In some embodiments, any of methods 1000, 1100, 1200 may include receiving an input to confirm, flag, or dismiss one or more confidence scores; tiles; classifications; prioritizations; quantity ranges or estimates or outputs; adequacy determinations; or quality indications.

In some embodiments, any of methods 1100, 1110, 1120 may further include outputting a diagnosis. An AI model, executed by ML/AI module 882, or a computer vision model, executed by computer vision model 888, may classify one or more cells of interest as benign, malignant, aneuploidic, etc.; and optionally output a diagnosis based on the classification.

FIG. 12 includes blocks S1110-S1170 of FIG. 11 and further includes receiving one or more images of one or more of the identified tiles from a secondary imaging system. A secondary imaging system may be used to image molecular or structural features of one or more cells in the identified tiles or perform real-time tracking, etc. for diagnostic, personalized medicine, and/or research purposes. For example, spectroscopy (SRS, CARS, Raman, FTIR), autofluorescence, second harmonic generation, multiphoton, or higher resolution QPI may be used (e.g., any of imaging subsystems 110, 210, 310, 410, 510, 610, 710).

The systems and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processor on the point-of-care device and/or a local or remote processing subsystem. The computer-readable medium can be stored on any suitable computer-readable media such as RAMs, ROMs, flash memory, EEPROMs, optical devices (e.g., CD or DVD), hard drives, floppy drives, or any suitable device. The computer-executable component is preferably a general or application-specific processor, but any suitable dedicated hardware or hardware/firmware combination can alternatively or additionally execute the instructions.

References in the specification to “one embodiment,” “an embodiment,” “an illustrative embodiment,” “some embodiments,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

As used in the description and claims, terms that may indicate an order or sequence, like first or second, may be used herein to simply differentiate between similar or like terms and should not construed to actually denote an order or sequence.

As used in the description and claims, the singular form “a”, “an” and “the” include both singular and plural references unless the context clearly dictates otherwise. For example, the term “wavelength” or “cell” may include, and is contemplated to include, a plurality of wavelengths or a plurality of cells, respectively. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

### EXAMPLES

Example 1. A point-of-care device for biopsy assessment, the device comprising: a receptacle configured to receive a biological sample therein or thereon; a light source configured to: emit light at a single or plurality of wavelengths between about 200 nm to about 1100 nm and illuminate at least a portion of the biological sample; an image sensor configured to: receive at least a portion of the emitted light and convert at least the portion of the emitted light to a signal; a memory configured to store processor-executable instructions; and a processor coupled to the memory and the image sensor, wherein the instructions, when executed by the processor, cause the processor to: receive the signal from the image sensor; convert the signal into a first image representing at least the portion of the biological sample; identify a first cell type represented in the first image and associated with at least the portion of the biological sample; determine whether a quality of the biological sample is above a predefined threshold based on the identified first cell type; and when the quality is above the predefined threshold, generate an indication of an adequacy of the biological sample.
Example 2. The device of any of the preceding examples, but particularly Example 1, wherein the biological sample is label free.
Example 3. The device of any of the preceding examples, but particularly Example 1, wherein the first cell type is a nucleated cell such that a nucleic acid of the first cell type absorbs light in a first wavelength range in the plurality of wavelengths.
Example 4. The device of any of the preceding examples, but particularly Example 3, wherein the quality of the biological sample comprises one or more of: a number of the first cell type, a clustering of the first cell type, or one or more characteristics of the first cell type.
Example 5. The device of any of the preceding examples, but particularly Example 3, wherein the processor is further caused to identify a second cell type in the first image.
Example 6. The device of any of the preceding examples, but particularly Example 5, wherein the second cell type is a red blood cell such that the red blood cell absorbs light in a second wavelength range in the plurality of wavelengths.
Example 7. The device of any of the preceding examples, but particularly Example 6, wherein the first wavelength range is between about 200 nm and about 300 nm; and the second wavelength range is between about 380 nm and about 460 nm.
Example 8. The device of any of the preceding examples, but particularly Example 6, wherein at least the portion of the biological sample is illuminated sequentially in the first wavelength range and the second wavelength range.
Example 9. The device of any of the preceding examples, but particularly Example 6, wherein at least the portion of the biological sample is illuminated substantially simultaneously in the first wavelength range and the second wavelength range.
Example 10. The device of any of the preceding examples, but particularly Example 5, wherein the processor is further caused to mask or remove indications of the second cell type in the first image to determine the quality of the biological sample.
Example 11. The device of any of the preceding examples, but particularly Example 10, wherein removing or masking comprises: digitally subtracting the second cell type from the first image based on one or more of: an absorption of one or more of the plurality of wavelengths, a refractive index of the second cell type, or a dry mass calculation of the second cell type.
Example 12. The device of any of the preceding examples, but particularly Example 1, wherein the processor is further caused to digitally or optically section the first image.
Example 13. The device of any of the preceding examples, but particularly Example 11, wherein the digital subtraction is performed using computer vision.
Example 14. The device of any of the preceding examples, but particularly Example 11, wherein the digital subtraction is performed using a machine learning algorithm.
Example 15. The device of any of the preceding examples, but particularly Example 1, wherein the first image comprises a first field of view such that one or more of: the receiving, identifying, or determining performed by the processor is executed while a second field of view is imaged by the image sensor.
Example 16. The device of any of the preceding examples, but particularly Example 15, wherein the processor is further caused to stitch together the first image of the field of view and a second image of the second field of view.
Example 17. The device of any of the preceding examples, but particularly Example 1, wherein the first image comprises a first field of view such that one or more of: the receiving, identifying, or determining performed by the processor is executed before a second field of view is imaged by the image sensor.
Example 18. The device of any of the preceding examples, but particularly Example 1, wherein the first image comprises a first field of view of a plurality of fields of view such that the receiving, identifying, determining, and outputting performed by the processor are executed after a remainder of the plurality of fields of view is imaged by the image sensor.
Example 19. The device of any of the preceding examples, but particularly Example 18, wherein the processor is further caused to stitch together a plurality of images captured using one or more of the plurality of fields of view before the outputting is performed by the processor.
Example 20. The device of any of the preceding examples, but particularly Example 1, wherein the identifying the first cell type comprises: generating a digital highlight to overlay a nucleic acid of the first cell type in the first image based on one or more of: an absorption of one or more of the plurality of wavelengths by the nucleic acid, a refractive index of the nucleus, or a dry mass calculation of the nucleus.
Example 21. The device of any of the preceding examples, but particularly Example 20, wherein the generating the digital highlight is performed using computer vision.
Example 22. The device of Example 20, wherein the generating the digital highlight is performed using a machine learning algorithm.
Example 23. The device of any of the preceding examples, but particularly Example 1, wherein the first image comprises a plurality of images for a plurality of fields of view, such that the processor is further caused to prioritize a subset of the plurality of images for generating the indication of the adequacy of the biological sample based on the identified first cell type in one or more of the plurality of images.
Example 24. The device of any of the preceding examples, but particularly Example 1, further comprising a diffuser configured to produce a unique diffraction image at the image sensor.
Example 25. The device of any of the preceding examples, but particularly Example 24, wherein the identifying the first cell of interest comprises determining a nuclear refractive index of a nucleus of the first cell of interest as compared to a cytoplasm refractive index of a cytoplasm of the first cell of interest or a refractive index of one or more other cells in the biological sample.
Example 26. The device of any of the preceding examples, but particularly Example 1, further comprising a translation apparatus coupled to the receptacle.
Example 27. A method performed by a point-of-care device for biopsy assessment, the method comprising: illuminating, with a light source, at least a portion of a biological sample, wherein the illuminating occurs in a first wavelength range of a plurality of wavelengths between about 200 nm to about 1100 nm; receiving, with an image sensor, at least a portion of emitted light from the light source; converting, with the image sensor, at least the portion of the emitted light to a signal; receiving, with a processor, the signal from the image sensor; converting, with the processor, the signal into a first image; identifying, with the processor, a first cell type represented in the first image and associated with at least the portion of the biological sample; determining, with the processor, whether a quality of the biological sample is above a predefined threshold based on the identified first cell type; and when the quality is above the predefined threshold, outputting, with the processor, an indication of an adequacy of the biological sample.
Example 28. The method of any of the preceding examples, but particularly Example 27, further comprising transmitting the first image to a remote processing subsystem, wherein the remote processing subsystem is configured to process the first image to output a diagnostic indicator of the first image.
Example 29. The method of any of the preceding examples, but particularly Example 27, wherein the biological sample is label free.
Example 30. The method of any of the preceding examples, but particularly Example 27, wherein the first cell type is a nucleated cell such that a nucleic acid of the first cell type absorbs light in a first wavelength range in the plurality of wavelengths.
Example 31. The method of any of the preceding examples, but particularly Example 30, wherein the quality of the biological sample comprises one or more of: a number of the first cell type, a clustering of the first cell type, or one or more characteristics of the first cell type.
Example 32. The method of any of the preceding examples, but particularly Example 30, further comprising identifying a second cell type in the first image.
Example 33. The method of any of the preceding examples, but particularly Example 32, wherein the second cell type is a red blood cell such that the red blood cell absorbs light in a second wavelength range in the plurality of wavelengths.
Example 34. The method of any of the preceding examples, but particularly Example 33, wherein the first wavelength range is between about 200 nm and about 300 nm; and the second wavelength range is between about 380 nm and about 460 nm.
Example 35. The method of any of the preceding examples, but particularly Example 33, wherein at least the portion of the biological sample is illuminated sequentially in the first wavelength range and the second wavelength range.
Example 36. The method of any of the preceding examples, but particularly Example 33, further comprising illuminating substantially simultaneously at least the portion of the biological sample is in the first wavelength range and the second wavelength range.
Example 37. The method of any of the preceding examples, but particularly Example 32, further comprising masking or removing indications of the second cell type in the first image to determine the quality of the biological sample.
Example 38. The method of any of the preceding examples, but particularly Example 37, wherein removing or masking comprises: digitally subtracting the second cell type from the first image based on one or more of: an absorption of one or more of the plurality of wavelengths, a refractive index of the second cell type, or a dry mass calculation of the second cell type.
Example 39. The method of any of the preceding examples, but particularly Example 27, further comprising digitally or optically sectioning the first image.
Example 40. The method of any of the preceding examples, but particularly Example 38, wherein the digital subtraction is performed using computer vision.
Example 41. The method of any of the preceding examples, but particularly Example 38, wherein the digital subtraction is performed using a machine learning algorithm.
Example 42. The method of any of the preceding examples, but particularly Example 27, wherein the receiving, identifying, or determining are performed while imaging a second field of view.
Example 43. The method of any of the preceding examples, but particularly Example 42, further comprising stitching together the first image of the field of view and a second image of the second field of view.
Example 44. The method of any of the preceding examples, but particularly Example 27, wherein the receiving, identifying, or determining are performed before imaging a second field of view.
Example 45. The method of any of the preceding examples, but particularly Example 27, wherein the identifying the first cell type comprises: generating a digital highlight to overlay a nucleic acid of the first cell type in the first image based on one or more of: an absorption of one or more of the plurality of wavelengths by the nucleic acid, a refractive index of the nucleic acid, or a dry mass calculation of the nucleic acid.
Example 46. The method of any of the preceding examples, but particularly Example 45, wherein the generating the digital highlight is performed using computer vision.
Example 47. The method of any of the preceding examples, but particularly Example 45, wherein the generating the digital highlight is performed using a machine learning algorithm.
Example 48. The method of any of the preceding examples, but particularly Example 27, wherein the first image comprises a plurality of images for a plurality of fields of view, wherein the method further comprises prioritizing a subset of the plurality of images for generating the indication of the adequacy of the biological sample based on the identified first cell type in one or more of the plurality of images.
Example 49. The method of any of the preceding examples, but particularly Example 48, wherein the receiving, identifying, determining, and outputting are performed after imaging a remainder of the plurality of fields of view.
Example 50. The method of any of the preceding examples, but particularly Example 48, further comprising stitching together a plurality of images captured using one or more of the plurality of fields of view before the outputting.
Example 51. A computer-readable medium comprising processor-executable instructions stored thereon that, when executed by a processor, cause the processor to: receive a signal from an image sensor, wherein the signal comprises at least a portion of emitted light, wherein the emitted light is in a first wavelength range of a plurality of wavelengths between about 200 nm to about 1100 nm; convert the signal into a first image; identify a first cell type represented in the first image and associated with at least the portion of the biological sample; determine whether a quality of the biological sample is above a predefined threshold based on the identified first cell type; and when the quality is above the predefined threshold, output an indication of an adequacy of the biological sample.
Example 52. The computer-readable medium of any of the preceding examples, but particularly Example 51, wherein the processor is further caused to: transmit the first image to a remote processing subsystem, wherein the remote processing subsystem is configured to process the first image to output a diagnostic indicator related to the biological sample represented in the first image.
Example 53. The computer-readable medium of any of the preceding examples, but particularly Example 51, wherein the biological sample is label free.
Example 54. The computer-readable medium of any of the preceding examples, but particularly Example 51, wherein the first cell type is a nucleated cell such that a nucleic acid of the first cell type absorbs light in a first wavelength range in the plurality of wavelengths.
Example 55. The computer-readable medium of any of the preceding examples, but particularly Example 54, wherein the quality of the biological sample comprises one or more of: a number of the first cell type, a clustering of the first cell type, or one or more characteristics of the first cell type.
Example 56. The computer-readable medium of any of the preceding examples, but particularly Example 54, wherein the processor is further caused to identify a second cell type in the first image.
Example 57. The computer-readable medium of any of the preceding examples, but particularly Example 56, wherein the second cell type is a red blood cell such that the red blood cell absorbs light in a second wavelength range in the plurality of wavelengths.
Example 58. The computer-readable medium of any of the preceding examples, but particularly Example 57, wherein the first wavelength range is between about 200 nm and about 300 nm; and the second wavelength range is between about 380 nm and about 460 nm.
Example 59. The computer-readable medium of any of the preceding examples, but particularly Example 57, wherein at least the portion of the biological sample is illuminated sequentially in the first wavelength range and the second wavelength range.
Example 60. The computer-readable medium of any of the preceding examples, but particularly Example 57, wherein at least the portion of the biological sample is illuminated substantially simultaneously in the first wavelength range and the second wavelength range.
Example 61. The computer-readable medium of any of the preceding examples, but particularly Example 56, wherein the processor is further caused to mask or remove indications of the second cell type in the first image to determine the quality of the biological sample.
Example 62. The computer-readable medium of any of the preceding examples, but particularly Example 61, wherein removing or masking comprises: digitally subtracting the second cell type from the first image based on one or more of: an absorption of one or more of the plurality of wavelengths, a refractive index of the second cell type, or a dry mass calculation of the second cell type.
Example 63. The computer-readable medium of any of the preceding examples, but particularly Example 51, wherein the processor is further caused to digitally or optically section the first image.
Example 64. The computer-readable medium of any of the preceding examples, but particularly Example 62, wherein the digital subtraction is performed using computer vision.
Example 65. The computer-readable medium of any of the preceding examples, but particularly Example 62, wherein the digital subtraction is performed using a machine learning algorithm.
Example 66. The computer-readable medium of any of the preceding examples, but particularly Example 51, wherein the first image comprises a first field of view such that one or more of: the receiving, identifying, or determining performed by the processor is executed while a second field of view is imaged by the image sensor.
Example 67. The computer-readable medium of any of the preceding examples, but particularly Example 66, wherein the processor is further caused to stitch together the first image of the field of view and a second image of the second field of view.
Example 68. The computer-readable medium of any of the preceding examples, but particularly Example 51, wherein the first image comprises a first field of view such that one or more of: the receiving, identifying, or determining performed by the processor is executed before a second field of view is imaged by the image sensor.
Example 69. The computer-readable medium of any of the preceding examples, but particularly Example 51, wherein the first image comprises a first field of view of a plurality of fields of view such that the receiving, identifying, determining, and outputting performed by the processor are executed after a remainder of the plurality of fields of view is imaged by the image sensor.
Example 70. The computer-readable medium of any of the preceding examples, but particularly Example 69, wherein the processor is further caused to stitch together a plurality of images captured using one or more of the plurality of fields of view before the outputting is performed by the processor.
Example 71. The computer-readable medium of any of the preceding examples, but particularly Example 51, wherein the identifying the first cell type comprises: generating a digital highlight to overlay a nucleic acid of the first cell type in the first image based on one or more of: an absorption of one or more of the plurality of wavelengths by the nucleic acid, a refractive index of the nucleic acid, or a dry mass calculation of the nucleic acid.
Example 72. The computer-readable medium of any of the preceding examples, but particularly Example 71, wherein the generating the digital highlight is performed using computer vision.
Example 73. The computer-readable medium of any of the preceding examples, but particularly Example 71, wherein the generating the digital highlight is performed using a machine learning algorithm.
Example 74. The computer-readable medium of any of the preceding examples, but particularly Example 51, wherein the first image comprises a plurality of images for a plurality of fields of view, such that the processor is further caused to prioritize a subset of the plurality of images for generating the indication of the adequacy of the biological sample based on the identified first cell type in one or more of the plurality of images.
Example 75. A computer-implemented method for biopsy assessment, comprising: receiving a low-resolution image; classifying one or more regions of the low-resolution image to identify regions having one or more cells of interest; weighting the identified regions to determine a prioritized order of one or more fields of view that comprise one or more of the identified regions; receiving a plurality of images of the prioritized fields of view to generate a high-resolution image; classifying one or more regions of the high-resolution image to identify one or more portions having the one or more cells of interest; and outputting an estimated quantity of cells present in the one or more identified portions.
Example 76. The method of any one of the preceding examples, but particularly Example 75, further comprising tiling the low-resolution image into a plurality of low-resolution image tiles, wherein the one or more regions of the low-resolution image are one or more tiles of the low-resolution image.
Example 77. The method of any one of the preceding examples, but particularly Example 75, further comprising tiling the high-resolution image into a plurality of high-resolution tiles, wherein the one or more regions of the high-resolution image are one or more tiles of the high-resolution image.
Example 77. The method of any one of the preceding examples, but particularly Example 75, wherein the classifying one or more regions of the low-resolution image comprises executing an artificial intelligence (AI) classification model.
Example 78. he method of any one of the preceding examples, but particularly Example 77, wherein the AI classification model assigns a confidence level to one or more classified regions.
Example 79. The method of any one of the preceding examples, but particularly Example 75, wherein the weighting comprises using a confidence score from the classifying for the identified regions based on a likelihood of a region having the one or more cells of interest.
Example 80. The method of any one of the preceding examples, but particularly Example 75, wherein the prioritized order of one or more fields of view (FOVs) comprises one or more contiguous regions combined into the one or more FOVs.

The method of any one of the preceding examples, but particularly Example 75, further comprising, before the classifying one or more regions of the high-resolution image, autofocusing the high-resolution image using an AI model trained on manually focused images.

What is claimed is:

1. A point-of-care device for biopsy assessment, the device comprising:
a receptacle configured to receive a biological sample therein or thereon;
a light source configured to: emit light at a single or plurality of wavelengths between about 200 nm to about 1100 nm and illuminate at least a portion of the biological sample;
an image sensor configured to: receive at least a portion of the emitted light and convert at least the portion of the emitted light to a signal;
a memory configured to store processor-executable instructions; and
a processor coupled to the memory and the image sensor, wherein the instructions, when executed by the processor, cause the processor to:
receive the signal from the image sensor;
convert the signal into a first image representing at least the portion of the biological sample;
identify a first cell type as a nucleated cell represented in the first image and associated with at least the portion of the biological sample, wherein a nucleic acid of the first cell type absorbs light in a first wavelength range in the plurality of wavelengths;
determine whether a quality of the biological sample is above a predefined threshold based on the identified first cell type; and
when the quality is above the predefined threshold, generate an indication of an adequacy and/or diagnostics of the biological sample.

2. The device of claim 1, wherein the biological sample is label free.

3. The device of claim Error! Reference source not found., wherein the quality of the biological sample comprises one or more of: a number of the first cell type, a clustering of the first cell type, or one or more characteristics of the first cell type.

4. The device of claim Error! Reference source not found., wherein the processor is further caused to identify a second cell type in the first image.

5. The device of claim 4, wherein the identifying comprises identifying the second cell type as a red blood cell, wherein the red blood cell absorbs light in a second wavelength range in the plurality of wavelengths.

6. The device of claim 5, wherein the first wavelength range is between about 200 nm and about 300 nm; and the second wavelength range is between about 380 nm and about 460 nm.

7. The device of claim 5, wherein at least the portion of the biological sample is illuminated sequentially in the first wavelength range and the second wavelength range.

8. The device of claim 5, wherein at least the portion of the biological sample is illuminated substantially simultaneously in the first wavelength range and the second wavelength range.

9. The device of claim 4, wherein the processor is further caused to mask or remove indications of the second cell type in the first image to determine the quality of the biological sample.

10. The device of claim 9, wherein removing or masking comprises: digitally subtracting the second cell type from the first image based on one or more of: an absorption of one or more of the plurality of wavelengths, a refractive index of the second cell type, or a dry mass calculation of the second cell type.

11. The device of claim 1, wherein the processor is further caused to digitally or optically section the first image.

12. The device of claim 10, wherein the digital subtraction is performed using computer vision.

13. The device of claim 10, wherein the digital subtraction is performed using a machine learning algorithm.

14. The device of claim 1, wherein the first image comprises a first field of view such that one or more of: the receiving, identifying, or determining performed by the processor is executed while a second field of view is imaged by the image sensor.

15. The device of claim 14, wherein the processor is further caused to stitch together the first image of the field of view and a second image of the second field of view.

16. The device of claim 1, wherein the first image comprises a first field of view such that one or more of: the receiving, identifying, or determining performed by the processor is executed before a second field of view is imaged by the image sensor.

17. The device of claim 1, wherein the first image comprises a first field of view of a plurality of fields of view such that the receiving, identifying, determining, and outputting performed by the processor are executed after a remainder of the plurality of fields of view is imaged by the image sensor.

18. The device of claim 17, wherein the processor is further caused to stitch together a plurality of images captured using one or more of the plurality of fields of view before the outputting is performed by the processor.

19. The device of claim 1, wherein the identifying the first cell type comprises: generating a digital highlight to overlay a nucleic acid of the first cell type in the first image based on one or more of: an absorption of one or more of the plurality of wavelengths by the cell, a refractive index of the cell, or a dry mass calculation of the cell.

20. The device of claim 19, wherein the generating the digital highlight is performed using computer vision.

21. The device of claim 19, wherein the generating the digital highlight is performed using a machine learning algorithm.

22. The device of claim 1, wherein the first image comprises a plurality of images for a plurality of fields of view, such that the processor is further caused to prioritize a subset of the plurality of images for generating the indication of the adequacy and/or diagnostics of the biological sample based on the identified first cell type in one or more of the plurality of images.

23. The device of claim 1, further comprising a diffuser configured to produce a unique diffraction image at the image sensor.

24. The device of claim 23, wherein the identifying the first cell of interest comprises determining a nuclear refractive index of a nucleus of the first cell of interest as compared to a cytoplasm refractive index of a cytoplasm of the first cell of interest or a refractive index of one or more other cells in the biological sample.

25. The device of claim 1, further comprising a translation apparatus coupled to the receptacle.

26. A computer-implemented method for biopsy assessment, comprising:
receiving a low-resolution image;
classifying one or more regions of the low-resolution image to identify regions having one or more cells of interest;
weighting the identified regions to determine a prioritized order of one or more fields of view that comprise one or more of the identified regions;
receiving a plurality of images of the prioritized fields of view to generate a high-resolution image;
classifying one or more regions of the high-resolution image to identify one or more portions having the one or more cells of interest; and
outputting an estimated quantity of cells present in the one or more identified portions.

27. The method of claim 26, further comprising tiling the low-resolution image into a plurality of low-resolution image tiles, wherein the one or more regions of the low-resolution image are one or more tiles of the low-resolution image.

28. The method of claim 26, further comprising tiling the high-resolution image into a plurality of high-resolution tiles, wherein the one or more regions of the high-resolution image are one or more tiles of the high-resolution image.

29. The method of claim 26, wherein the classifying one or more regions of the low-resolution image comprises executing an artificial intelligence (AI) classification model.

30. The method of claim 29, wherein the AI classification model assigns a confidence level to one or more classified regions.

31. The method of claim 26, wherein the weighting comprises using a confidence score from the classifying for the identified regions based on a likelihood of a region having the one or more cells of interest.

32. The method of claim 26, wherein the prioritized order of one or more fields of view (FOVs) comprises one or more contiguous regions combined into the one or more FOVs.

33. The method of claim 26, further comprising, before the classifying one or more regions of the high-resolution image, autofocusing the high-resolution image using an AI model trained on manually focused images.
